(19) United States
(12) Patent Application Publication
(10) Pub. No.: US 2004/0035967 A1
(43) Pub. Date: Feb. 26, 2004

(54) Gyratory crusher with hydrostatic bearings

(76) Inventors: Louis Wein Johnson, Eugene, OR (US); Bruce Gordon Johnson, Monroe, OR (US)

Correspondence Address: LOUIS W. JOHNSON, 345 PALOMINO DRIVE, EUGENE, OR, 97401, US

(21) Appl. No.: 10/225,778

(22) Filed: Aug. 23, 2002

(51) Int. Cl. B02C 2/00

(52) U.S. Cl. 241/207

(57) ABSTRACT

A rock crusher of the gyratory cone type having a mainframe structured to be exceptionally strong yet lighter and less costly to manufacture. A tapered spindle bolted to mainframe, is drilled with multiple oil holes, is hollow for circulating heating/cooling fluid, and supports an adjustable thrust bearing. An eccentric member journals on spindle; eccentric has outer taper offset and canted relative to inner taper, and each taper has concentric cylinderical extensions; A gyrating conical member journals on eccentric. Said thrust bearing having spherical surfaces supports conical member on said spindle. A double reduction gear train transfers power to eccentric. Flow dividers direct lubricant to specific multiple ports for hydrostatic lubrication to conical and thrust bearings. Counterbalancing means. A detachable top frame positioned on top of mainframe is restrained against radial and circular movement. Pivoting hooks and hydraulic cylinders tilt outward facilitating rapid servicing. Gas accumulators with hooks and cylinders restrain top frame against crushing forces, yield to non-crushable objects. Detachable top frame has internal thread engaging an external thread of a rotatable member that when rotated adjusts for product sizes and replacement of wear parts; a means to lubricate said threads. Power means to unlock, rotate, and lock said rotatable member.

A wear resistant mantle is clamped to gyrating conical member by hydraulic means. A wear resistant liner is held in rotatable member by slidable wedges.

### BACKGROUND OF THE INVENTION

Nations can only have an advanced structure and mobile society if they have paved roads, railroads, airports, dams, buildings, foundations for houses, and countless other things that require crushed rock and other rock products; in fact, all people live in an ongoing Stone Age and always will. The volumes and tonnages of sand, gravel, crushed rock, cement, and ore far exceeds any other products in the United States. As in most businesses there is substantial competition both within the producers of rock products, and also those who manufacture machinery for such purposes. Gyrating cone crushers are the machines of choice for crushing the harder and more abrasive rock. The more efficient, durable, and economical a cone crusher can be the better it serves all concerned. Rock crushers should be structurally very strong to withstand the enormous pressures imposed, yet should not be so over designed that they become too heavy and too costly. It is more logical to use portable crushing plants at nearby rock sources to the places of use than if the hauling distances are too far from stationary commercial rock sources to the places of use; plus portable crushing plants can be built for much greater production, e.g. for highway construction, than most commercial plants. Crushers for portability must be of compact dimensions and low weight consistent with acceptable capacity and low maintenance; such a machine is the subject of our request for patent rights; it has several new concepts that will prove to be extremely advantageous for both portable and stationary use.

### SUMMARY OF THE INVENTION

According to the present invention and forming a primary objective thereof, a novel combination of means to construct a very rugged and efficient rock crusher of the gyrating cone type, and to achieve this objective by designing a machine that is of less weight, lower costs to manufacture, easier to service, and more user friendly than other makes of this type of rock crushers now known. The first means is a new concept of main frame that eliminates a massive annular gear chamber and a hollow center for bearings or an embedded post shaft either of which is used by all other makes of gyrating cone type crushers. Our new design provides simple full depth straight crossbeams to better resist the enormous forces of crushing rock, ore, or other materials by the compression method of crushing. The second means is to have a better bearing concept that is far less costly than roller bearings but will run as accurately, and a bearing that is not subject to thermal clamping seizures as are bushing type bearings. A third means is the use of a double gear reduction drive between power input and an eccentric that gyrates the crushing member so as to enable the use of higher speed motors which are less costly than slower speed motors and weigh less, also smaller less costly sheaves are used. A forth means is a new concept to restrain the gyrating member from spinning when the crusher is running but not being supplied with crushable material. A fifth means is a novel way to hold a cone head mantle firmly in place by hydraulic clamping and release. A sixth means is an improved method of retaining a bowl liner within a bowl member with slidable wedges. A seventh means is a totally new concept of a tramp metal relief system where hook like means can swing outward to enable rapid removal of a bowl assembly. An eighth means having an adjusting system contained in a rigid enclosure that protects the entry of stray rocks or similar and rainfall. Within said enclosure a slidable member guided by roller means and actuated by hydraulic means and having a pivoting pawl to engage vertical spaced apart lugs attached to a ring like member; said hydraulic means push and pull said slidable member that will turn said ring like member when said pawls are engaging said lugs. Said pawl engages and disengages said lugs by hydraulic means. Two of said enclosures are used and are 180° apart for balanced thrust.

### BRIEF DESCRIPTION OF THE DRAWINGS

Having introduced the purpose of this application, we now list the numbers that we have assigned to its parts. We refer to drawing pages 1 through 22 and FIGS. 1 through 49. The purpose each part serves will be explained later.

Page 1 FIG. 1 is a perspective view of our fully assembled rock crusher; 1-MF is the main frame; 1-BA is the bowl assembly; 326 is an adjusting unit; 341 is a gas charge accumulator; 281 are hook-like members; 275 are hydraulic cylinder assemblies; 294 are anchor plates; 293 are manifold tubes; 290 are manifold to cylinder tubes; 298 are thrust absorbing members; 24 is a lube oil drain; 224 are anti-rotation stop blocks; 222 are depending arm anti-rotation stops; 220 is a bowl nut; 243 is an adjustment ring; 400 is a driven sheave.

Page 2 FIG. 2 shows a perspective view of the main frame with hydraulic cylinders 275 and hook-like members 281 tilted outward; 276 are connecting links; 1-BF is a base flange, and 1-W is a cylindrical wall of the main frame 1-MF; 218 is a V-ring; 119 is a wear mantle; 342 are lifting brackets.

Page 3 FIG. 3 is a vertical section view through the crusher; 33 is a spacer brace and a wear protector; 263 is a wear liner; 333 is a large socket head cap screw; other numbers are detailed in subsequent FIGs; plus other numbered features that cannot be shown in this view.

Page 4 FIG. 4 is a plan view of the lower half of the main frame; 1-BF is the bottom flange of said main frame; 2 are beams; 3 are end plates welded to beams; 4 is a bearing housing support with precision bore 22 and drain port 24 integral; 5 are support plates for 4; 7 is a bearing housing support; 23 is a precision bore in 7; 6 are arcuated walls; 9 are upright members; 10 is a circular plate member; 12 is a centering pin in 10; 12-H is a centering hole in beams 2; 11 are lube oil conducting members; 8 are attachment shelves; 20 are cover plates;

FIG. 5 is a vertical sectioned view through B-B′ FIG. 4; 35 are oil drain ports in beams.

Page 5 FIG. 6 is a vertical sectioned view taken through C-C′ of member 10

FIG. 7 showing centering pin 12, 17 are lube oil holes, 19 are threaded holes, 18 are drain holes, 13 is an oil deflector ring, 28 is a precision recess, 29 is seal groove, 32 is a seal ring shoulder. FIG. 7 is a plan view of member 10: 21 is a precision bore 21, 30 is a gear inspection hole, 14 is an oil deflector, 33 and 34 are larger oil holes than 17, 25 and 26 are heating/cooling fluid holes, 27 is an annular oil drain;

FIG. 8 is a detail view through E-E′: 16 are recesses for elastomer seals at the top ends of all oil and heating/coolant holes shown in FIG. 7.

FIG. 9 is a detailed view of 13 and 27 taken through F-F′ FIG. 7;

FIG. 10 is a detailed view taken through D-D′ of FIG. 7 showing deflector 14 and nozzle 15; 142 is an oil hole.

Page 6 FIG. 11 is a plan view of the top of member 38 a fixed spindle; 40 is a bolting flange with counterbored holes 41; 42 are flutes (grooves) with tapered edges; 44 are three evenly spaced smooth bored holes; 45 are evenly spaced threaded holes; 47 is opening for a gear; 46 are multiple threaded holes in a recessed face; 43 is a conical surface;

FIG. 12 is a vertical view of 38; D is a large diameter of taper 43 and D′ is its small diameter; 48 is a cylindrical extension of D′ diameter; 49 are hydrostatic lubrication grooves; 39; are annular grooved lube oil distributors.

FIG. 13 is a detail of grooves 39 and 55 oil lines;

FIG. 14 details transfer nipples 50 with one of two elastomer seal rings 51 in place.

Page 7 FIG. 15 is a plan view of the bottom face of spindle 38; 41 are multiple lube oil holes; 52 are multiple lube oil holes; 55 are oil holes; 53 is a fluid inlet; 54 is a fluid outlet;

FIG. 16 is a vertical sectioned view of spindle 38 taken through gear opening 47; 61 is a cast hollow chamber; 62 is an overflow exit tube; 57 is a fluid tight tubular chamber; 56 is a precision bored recess; 58 is a solid disk; 59 is an elastomer seal ring in 58; 60 is a retaining ring;

FIG. 17 is an enlarged view of annular grooves 39

Page 8 FIG. 18 is a vertical view of 65 a conical eccentric member; 66 are flutes with tapered edges; 68 are oil holes with tapered threads at outer ends; 70 is a keyway; 2X is the diameter between A-1 and A-2 arcs,

FIG. 19. FIG. 19 is a plan view; 67 are slots open at the large end of the taper of 65; A-1 is an arc of less than 180°; A-2 is a smaller arc than A-1; X are radii between said arcs and of shorter radius than said arcs;

FIG. 20 is an enlarged view of 68;

FIG. 21 is an enlarged view of nozzles 69.

Page 9 FIG. 22 is a vertical sectioned view through the plane of the eccentric 65; 64 is a cylindrical extension concentric to centerline 102; 63 is a cylindrical extension concentric to centerline 101; 72 is an annular groove; 72-H are pressure relief holes; 69 are nozzles; 74 is a centering bore; 101 is the centerline of inner cone 73; 102 is centerline of outer cone of 65; angle α is established by 101 and 102;

FIG. 23 is a plan view of the bottom; 70 are one or more keyway slots; 71 are multiple threaded holes on radius R-5.

Page 10, because of an over-sight Page 10 was drawn after all other FIG drawings were established and numbered, consequently its FIG numbers are not in sequence as they should have been; however, page numbers are in sequence for a better understanding of how parts fit together. FIG. 48 is a plan view of the eccentric drive plate 150; E is the eccentric offset and the center of radial line R-1; R-2, R-3, and R-4 are centered on the machine's center line; E/2 is the center of R-5 bolt circle; 192 are cap screw holes on said bolt circle; 70 are keyways; 18 are multiple lube oil drains; 155 are up standing bars; 399 are counterweight clamps; 72 are threaded holes; 80 are dust seal retaining bosses; FIG. 49 is a vertical partially sectioned view showing eccentric 65 with drive keys 77, an internal tooth gear 130 bolted to 150, 155s embedded in 150 and retained by cap screws, and a section of a labyrinth seal ring 36.

Page 11 FIG. 24 is a vertical view of cone head 75; 76 is a conical area raised above the conical surface of 75; 80 is a dust seal retaining boss; 119 is a sectioned view of a mantle (wear liner);

FIG. 25 is a plan view of the lower surfaces of 75; 78 are multiple struts; 79 are cavities; 83 is a flat surface; 85 is a conical surface; 86 are precision spaced holes; 87 is a precision bore.

FIG. 26 is a sectioned plan view of 75 and 76.

Page 12 FIG. 27 is a vertical section view of cone head 75; 100 is the vertex of center lines 101 and 102, 103 is the amplitude of gyration; 78 are multiple struts, 79 are cavities; 81 is a converging conical bearing surface; 82 is a cylindrical bearing surface; 89 is gyrating clearance; 92 is a conical surface; 88 is a smooth precision bore; 85 is a conical surface; 80 is a positive angled boss; 90 is an annular seal ring groove; 91 is an extended cylindrical section.

Page 13 FIG. 28 is enlarged vertical section view of an assembled cone head; 93 is a piston; 94 is a cylindrical extension threaded into 93; 95 is an elastomer seal ring, 96 is an elastomer seal ring; 97 are pins; 105 is a copper ring; 120 is backing material; 98 is a conical washer-spacer; 99 is a cap screw with a double conical head; 122 is a protection wear cap retained by cap screw 333 see FIG. 3; 334 is a set screw and nut; 110 is the body of a valve; 118 is an oil hole; 121 is an oil pump extension; 106 is a spherical thrust bearing member; 107 are cap screws; 108 is a universal joint; 109 is half of a jaw clutch with a conical extension; 103 is the amplitude of gyration.

FIG. 29 is an enlarge sectional view of 110; 11 is a ball; 112 is a spring; 113 is a headless screw with a hex hole through it; 114 is a ball; 115 is a vent; 116 is a cap screw; 117 is an oil fitting.

Page 14 FIG. 30 is a vertical section view through the drive train gearing; 124 is a bearing housing extension of shaft enclosure 156; 125 is an input shaft journaled in bearings 131; 134 is a bearing adjustment mechanism; 138 is a sealing member, 139 is a wear sleeve; 329 is a closure cover; 136 are shims at two places; 137 is a seal ring; 145 is a dike; 126 is a spiral bevel pinion gear; 127 is a mating spiral bevel gear (both too difficult to draw the teeth); 128 is a vertical gear shaft; 129 is a spur gear; 130 is an internal tooth gear; 193 are gear and eccentric retaining cap screws; 133 is a roller bearing; 140 is a spacer; 141 is a spacer oil slinger; 132 is a ball bearing; 134 is a lock nut and locking washer; 135 is a bearing housing; 143 is a bearing retainer plate; 142 is an oil passage way; 24 are oil drains to a reservoir not shown; 36 are dust seals; 37 is a seal ring spacer; 151 are counterweights; 153 are spaces between counterweights; 154 are spacers; 152 are fine tuning balancing weights.

Page 15 FIG. 31 is a vertical section view of thrust bearing member 160 mounted on spindle 38; 161 is a bearing quality metal bonded to 160; 163 are adjustment shims; 162 are clamping cap screws; 164 are arcuated closed end galleries machined into 161; 165 are jacking screws; 50 are lube oil transfer nipples; 174 is the female half of jaw clutch 109; 158 is a tubular motor mount; 159 are cap screws; 167 is a hydraulic motor; 168 is a valving member; 379 are cap screws; 170 is a universal joint; 171 is a male spline shaft; 172 is a female spline; 173 is a coil spring; 191 is a port opening in 158; 190 is a vent opening in 158; 166 is a pressure relief hole in 160.

FIG. 32 is a cut away view of 168; 180 is a valve seat; 181 is a ball; 179 arc bolt holes; 182 is stop pin; 183 is a closure of a machining access; 184 is an oil passage way; 185 is a hole; 186 is a ball; 187 is a coil spring; 188 is a pressure adjusting screw; 189 is a two way oil flow passage; 194 is an optional venting port.

Page 16 FIG. 33 is a plan view of our hydrostatic lubrication system and heating/cooling fluid connections; 200 and 201 are flow dividers; 203 is a flow proportionator; 195, 196, and 197 are connectors to hydraulic hoses from a pump source; 198 are T fittings; 199 are lube oil tubes from Ts to flow dividers; 204 and 205 are multiple lube oil tubes to members 11; 210 are distribution tubes to specific connections; 207 and 206 are larger tubes with different flow volumes than 204 and 205; 208 and 209 are heating/cooling fluid connectors; 292, 293, and 295 are detailed on page 19 FIG. 40.

Page 17 FIG. 34 is a vertical section view of the top frame assembly 1-BA; 220 is a bowl nut; 240 is a bowl; 221 are platform extensions of 220; 218 is an annular V-ring pressed into the main frame 1-MF; 219 is one of several grease fittings; 222 is a depending arm; 223 is a platform welded to main frame; 224 is a stop block; 225 is a drain hole; 263 is a wear liner; 120 is backing; 246 are cavities between struts 245; 260 are cover plates welded over said cavities; 241 is modified thread form; 242 and 243 form an adjustment ring; 244 are equally spaced lugs welded to 243; 235 is a locking nut; 234 are thrust rods; 232 are pistons; 230 are cylinders; 231 are cylinder retaining cap screws; 233 are hydraulic lines joining cylinders 230; 245 are gussets forming openings 264; 268 is a depending band joined to 235; 247 are elastomer dust and moisture seals; 248 is a hopper for 250;

FIG. 36 is an enlarged plan view taken through G-G′; 250 is a slidable wedge; 253 is a thrust absorbing member; 251 is a cover washer; 254 is a bolt; 255 is a nut; 256 is a washer; 252 is a clamping cap screw; 259 is an elongated slot; 257 is a vertical slot in 250; 258 are guides; 266 is a wedging ramp with a conical radius; 261 is a 360° dike. FIG. 35 is an enlarge section of female thread 226; 227 is a small annular groove cut in the thrust flank of 226; 228 are multiple lubrication holes into 227 and having threads for fittings. 250 is a slidable member; 253 is; 265 is a bowl wear liner; 262 is an elastomer dust seal.

Page 18 FIG. 37 is an enlarged vertical view of part of the top frame 1-BA; 235 a locking nut; 268 is a metal band; 236 is an elastomer seal; 230 is a partially sectioned hydraulic cylinder; 231 retaining cap screws; 232 are pistons; 245 are gussets; 233 are connecting tubes or hoses; 269 is an expansion/contraction configuration for tubes; 270 is a hydraulic hose from a power source;

FIG. 38 is an enlarged plan and vertical section view of multiple cylinders 230; 237 is an elastomer seal; 271 is an oil passage through 230 with a side hole into each cylinder chamber.

Page 19 FIG. 39 is a tangential view of one assembly of our relief system; 294 are anchor members; 246 is a hole for oil passage; 299 is a valve; 295 are header plates; 299 is a valve; 276 are links; 277 are pins; 278 are retaining rings; θ is a limiting angle; 279 are air filters; 275 are cylinder assemblies; D is cylinder diameter; S is ram diameter; 280 are devises; β is a limiting angle; 281 are hook like members; 282 are concave discs; 283 are convex pads having positioning stems; 284 are precision holes; 285 are spherical headed shoulder pins; 286 are threaded blocks with headless screws; R is a long radius centered at lowest 277 pin ; r is a shorter radius centered at clevis pin.

FIG. 40 is a radial view of FIG. 39; 287 is a lubrication fitting; 293 is a tube manifold with slip connector 292 joined to it; 297 are saddle blocks; 298 are thrust transfer members; 296 is a threaded hole into one 294; 289 is a 90 deg. attachment to 275; 290 is a connecting tube of d diameter; 300 is an air bleed valve; 301 is a spacing pad; see FIGS. 41 and 42 page 20 for detail of 275.

Page 20 FIG. 41: 306 is a piston; 313 is a back-up ring; 314 is an elastomer seal; 315 is a non metallic band; 316 is a pipe plug; 307 is a piston rod of S diameter; D is cylinder diameter; D′ is a diameter larger than D; 318 is a travel space; 317 is an elastomer seal; 323 is a taper in 292 and 289; L is the distance from the center line of 275 to the center line of 290; N is an offset; 324 is an eye plate welded to 275;

FIG. 42: 305 is a threaded cylinder head; 322 is a seal ring groove 308 is an elastomer seal; 310 is a bushing; 309 is a retaining ring; 311 is an elastomer seal; 312 is a rod wiper; 320 are wrenching flats; 321 is a taper thread; 319 are recesses for pin wrench.

Page 21 FIG. 43 is a tangental vertical partially sectioned view through our power adjustment system 326 and part of top frame 1-BA. 222 is a depending arm; 223 is a fixed platform; 224 is a reversible stop block; 352 is a base plate; 353 are spacing end plates; 354 is a spacer plate with hydraulic couplings through it; 355 is a spacer plate with slot 356 through it; 357 is an angle iron spacer and thrust absorbing member; 358 are gussets welded to 357; 382 is a spacer end plate. 350 is an arcuated inner wall; 351 is a flat outer wall; 360 is a push/ pull hydraulic ram; 359 are coupling pins; 361, 362, 376, and 377 are hydraulic hoses; 364 is a sliding bar; 363 is a bracket welded to 364; 365 are guide rollers; 385 are key axles; 368 are axle locking arms; 383 is a section cut out of wall 350.

FIG. 44 is a plan view of FIG. 43; 242 and 244 are a section of the adjustment ring 243; 370 is a bi-directional pawl; 371 is its pivot axle; 372 is an axle locking arm; 373 and 374 are extended grippers; 375 is push/pull hydraulic ram; and attached to cover 381; 380 are cover guards over 364;

Page 22 FIG. 45 is an inside vertical section view of one of the roller assemblies of 326; 367 are axle supports; 385 and 387 are horizontal axles and 386 are vertical axles; 389 are threaded holes; cap screw 392 locks arm 368.

FIG. 46 is a plan view of FIG. 45; end spacer plate 382 is cut out for bar 364 at both ends; plates 390 FIG. 47 fill openings above 382.

FIG. 47 is an end view of 326 adjusting assembly; 390s are attached to cover 381; 391 are clamps to hold 380.

18 is for all drains not otherwise numbered and is used in several different FIGS.

### DETAILED DESCRIPTION OF DESIGN OF PREFERRED EMBODIMENTS

Page 1, FIG. 1 shows a perspective view of a fully assembled rock crusher that is the subject of our invention; The numbered parts are shown in detail on pages 3 through 22 and FIGS. 3 through 49 of the drawings. In FIG. 1: 341 is one of two gas-pressurized accumulators; a second accumulator, out of view, works in parallel with 341 to provide ample capacity for their duty. Both accumulators are connected to manifold tubes 293; vertical tubes 290 conduct pressurized oil from 293 to hydraulic cylinders 275. Hook shaped members 281 are connected to hydraulic cylinders 275. Column 298 transfers the thrust of 290 into the main frame l-MF, because 290 has slip connections at each of its ends and therefore acts like a piston. The object of this new concept is to provide extremely rapid and easy removal of the bowl assembly 1-BA from the main frame; two workers can release the accumulator pressure and tilt the swing hooks and cylinders clear of the flange of 1-BA and attach lifting cables and have the bowl assembly sitting on the ground within twenty minutes; other designs common in cone crushers require several man- hours to remove large nuts and nut locking devises plus careful guidance by several men when lifting their bowl assembly over many large threaded rods and repeating such care at reassembly. For example: our new unique system enables two men plus a crane operator to remove the bowl assembly from the main frame, remove worn liners, replace with new, pour backing epoxy, and reassemble within three hours in the more popular mid size crushers; no other cone crusher can closely match this. When down time of such costly operations as rock plants are is factored in, the cost savings of our design are enormous! 24 is a lube oil drain to a reservoir not shown; 224 is a stop block that resists the torque of depending arm 222. In cone type crushers there is a main frame, and resting upon it is a removable bowl assembly that is designed to lift when uncrushable objects enter the crushing chamber; also there is a tendency for the bowl to “float” slightly during very severe crushing; these actions causes the bowl assembly to try to creep relative to the main frame; this can not be permitted, hence the antirotation stops; usually there is wear between antirotation stops with all makes of cone crushers, with our design 224 is reversible and 222 can be removed repaired with weld metal and reattached; this can also be done with 224. Pressures in GAS over OIL design are adjusted to resist lift of crushing rock but to allow lift by uncrushable objects; Louis Johnson, co-inventor of this application, is the original inventor of combining accumulators with hydraulics for rock crusher protection systems; see Johnson U.S. Pat. No. 3,18,623 and U.S. Pat. No. 4,192,472. 1-BA is a bowl assembly that contains a rotatable member to which is attached 243 adjustment ring; 326 is one of two opposed power adjusters that rotate 243; when activated the crusher product is sized as desired; 400 is a driven V belt sheave that transfers power input to activate all rotating and gyrating members.

Page 2 FIG. 2 shows the main frame with bowl assembly removed; hooks 281 and cylinders 275 are tilted outward to their stop position thereby providing ample clearances for lifting the entire bowl assembly; 218 is a hard steel V-ring pressed into the top of the main frame and upon which bowl nut 220 seats, FIG. 1; 119 is a wear mantle seated on a cone-head and retained by a combined hydraulic piston and cap screw unit; 342 is one of three lifting brackets; 276 are links that connect 275 to 294 and allow limited tilting of 275.

Page 3 FIG. 3 is vertical section view taken through the gear train; it shows how most of the parts fit together; the numerous numbers are required to point out all the new concepts of our invention as well as those parts that are not new art but essential to assist in understanding our machine; 331 braces the wall 1-W to insure constantly the exact spacing of bearings 131 and to prevent any erosion of bearing housing 156; 263 is a sectioned wear liner that protects wall 1-W from rock erosion and is held by bolts for easy replacement; 333 is a large socket head cap screw that holds wear cap 122 which protects 99 a conical headed cap screw; FIG. 28 page 13 details said concepts.

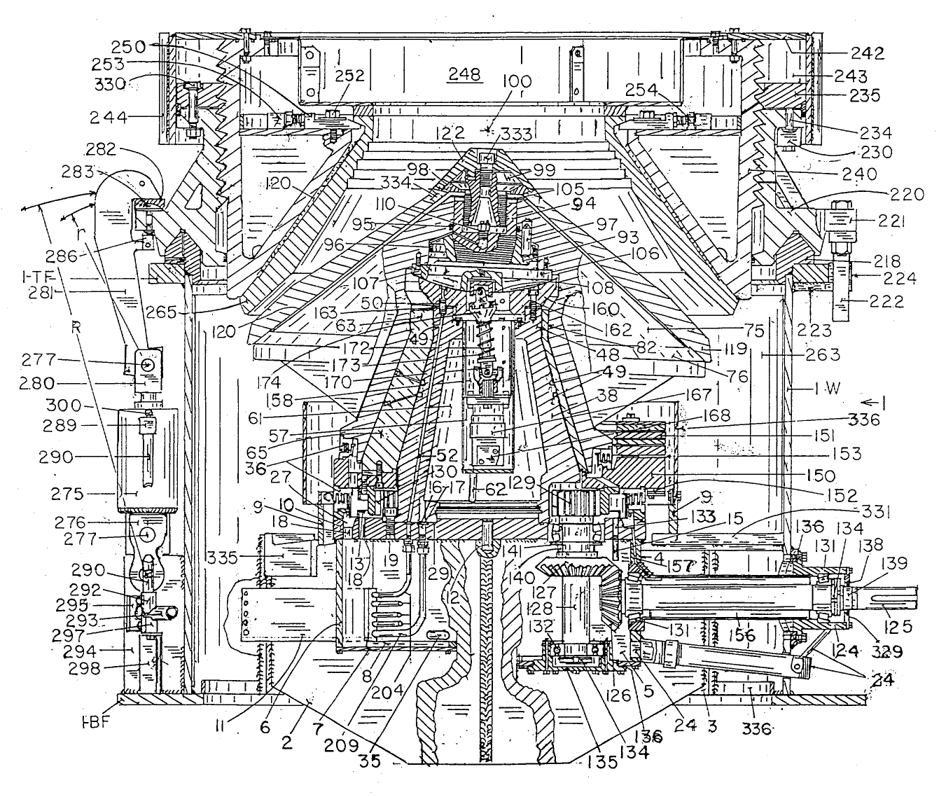

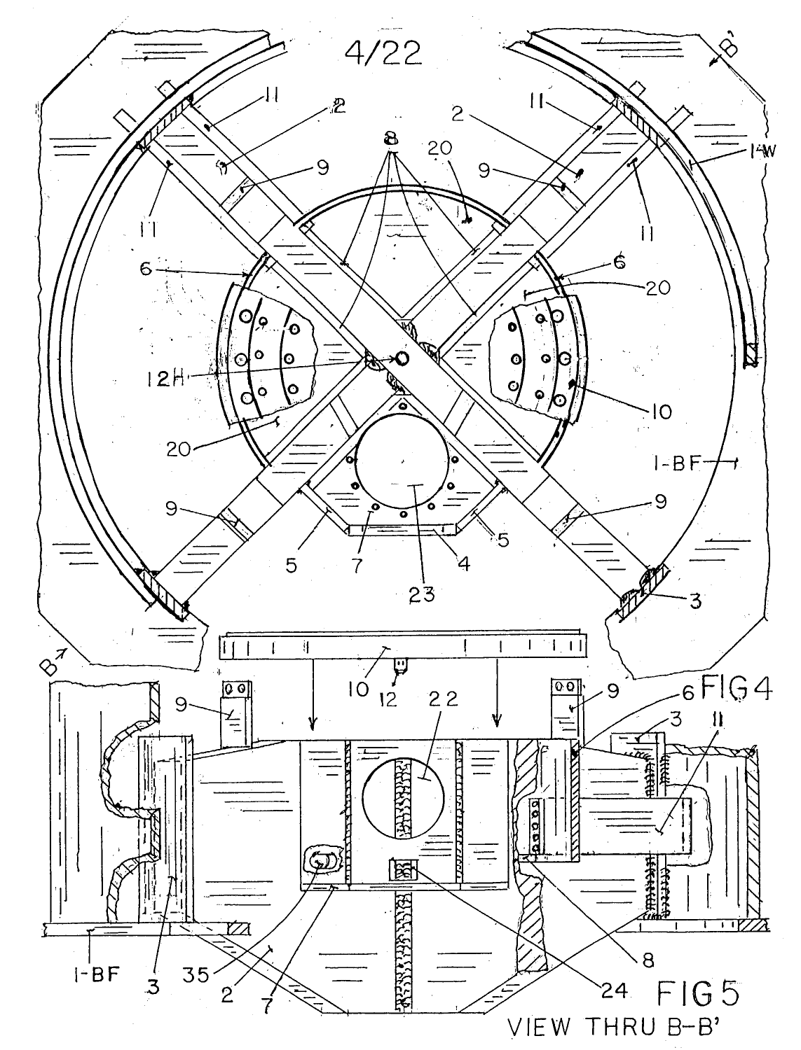

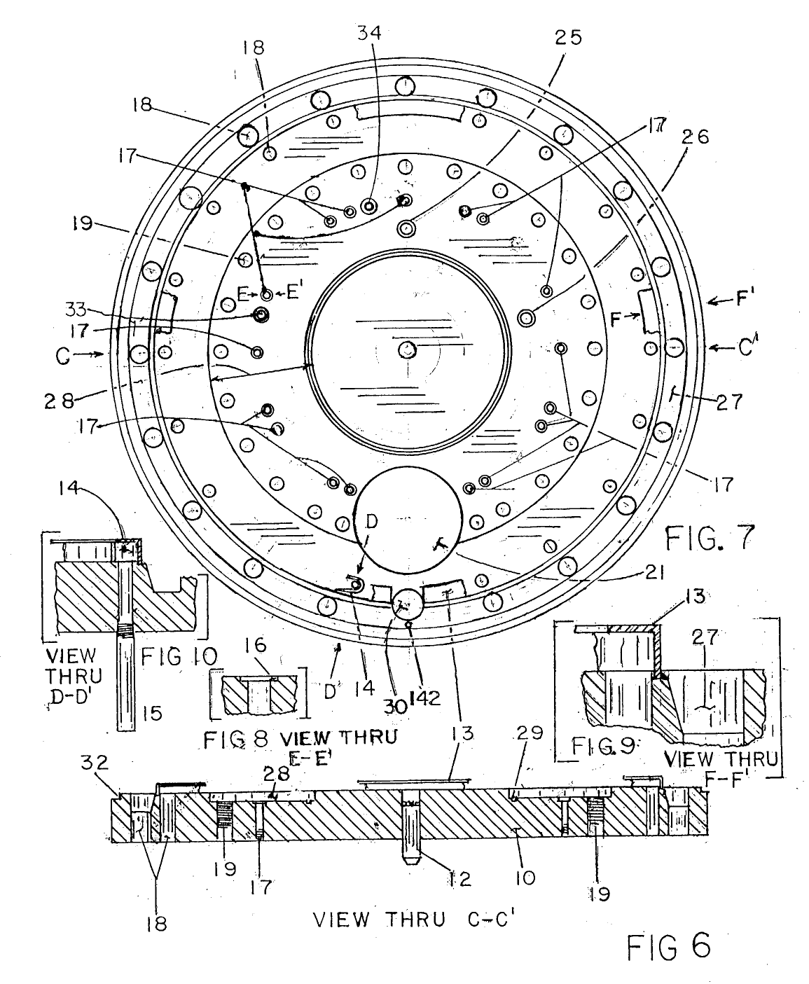

Page 4 FIG. 4 is a plan view of lower section of the main frame; 2 are full depth crossbeams spanning across the inside diameter of 1-W less the thickness of endplates number 3 the outer faces of which are machined the same radius as 1-W's inside diameter; beams 2 are configured to have near uniform strength across their lengths; one beam is full length with two half length beams minus thickness of first beam forming the other beam; all said beams are prep machined including drains 35 before being fully welded together to form a 90° X frame; the center top faces of said beams are machined flat and square to the vertical centerline of said main frame; members 8 each are blind threaded to receive cap screws and are then positioned and welded to each side of beams 2 in all four quadrants; arcuated members 6 are premachined prior to being positioned at the same radius through three quadrants; the bottom faces of 8 and 6 are on the same plane; members 4 and two 5s form a support for a bevel gear housing the upper faces of members 4, 5, and 6 are face machined simultaneously with beams 2 with all in the same plane; the radius and lower ends of members 3 are machined concentric to the Frame's axis and to the same radius as the inside diameter of wall 1-W; cover plates 20 are attached to 8 and 6 with gaskets between by cap screws at final assembly of a complete machine. Member 10 is fully machined before welding; pin 12 is inserted at its center before it engages hole 12-H which centers 10 on beams 2; bore 21 in member 10, page 5 FIG. 7, is positioned precisely with a gage over bore 23 in plate 7; 10 is welded to 2s at specified places and fully welded to 4, 5, and 6; this procedure forms four oil tight chambers and adds strength and stiffness to beams 2, and saves time and costs of vertically machining the two bores later and premachines parts that are inaccessible after assembly. After this procedure is complete, the assembly is positioned on base flange 1-BF and secured with welds; cylinderical wall, 1-W, is a rolled steel plate without its ends joined; it is wrapped around said assembly with one end centered on one end plate 3; 1-W is forced to match a circular score line etched into 1-BF and is tack welded as necessary when being positioned through 360°; its joining gap is then welded about the height of member 3. A top flange 1-TF, FIG. 3, is premachined at its inside and outside diameters and one face; the inner bore has a small chamfer, and 1-W has a hand ground chamfer to facilitate said flange to being forced over said wall to an exact distance above 1-BF; both are skip welded as 1-W is forced against 1-TF free of any gaps; anchor plates 294, FIGS. 3 and 39 page 19, are positioned and partially welded. The whole assembly is now ready for complete welding; after which the top inside diameter of 1-W and top face of 1-TF and its O.D. are machined to specific dimensions. Any top face warpage to 10 by welding is corrected by machining at this time.

Page 5 FIGS. 6 and 7 detail member 10's construction before welding to beams 2 and chambers formed by arcuated members 6: the top face of member 10 is recessed at 28 to exact inner and outer diameters to match a press fit to member 38, a spindle; multiple holes 19 are precision drilled and partially threaded for large cap screws to pull said spindle tightly against the bottom face of recess 28; bore 21 is precision bored an exact distance from center for gear meshing; holes 17 with recesses 16 FIG. 8 are precisely positioned as are holes, 33, 34, 25, and 26 to match holes in said spindle; gear inspection hole 30 is drilled; annular groove 27 and a boss for positioning member 13 are machined; multiple drain holes 18 are positioned to avoid being obstructed by beams 2; hole 12-H is drilled on center; boss 32 is machined to hold a seal spacer; the bottom surface of member 10 is faced and holes 17, 25, 26, 33, 34, and for nozzle 15 are threaded; hole 142 is drilled after the base frame is virtually completed.

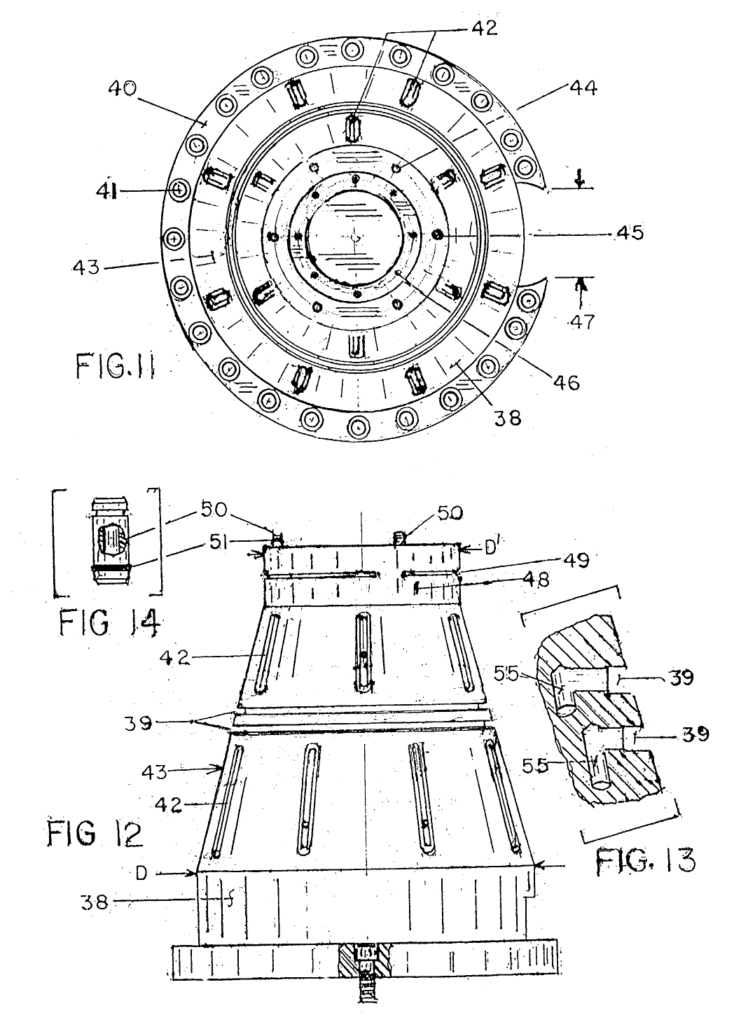

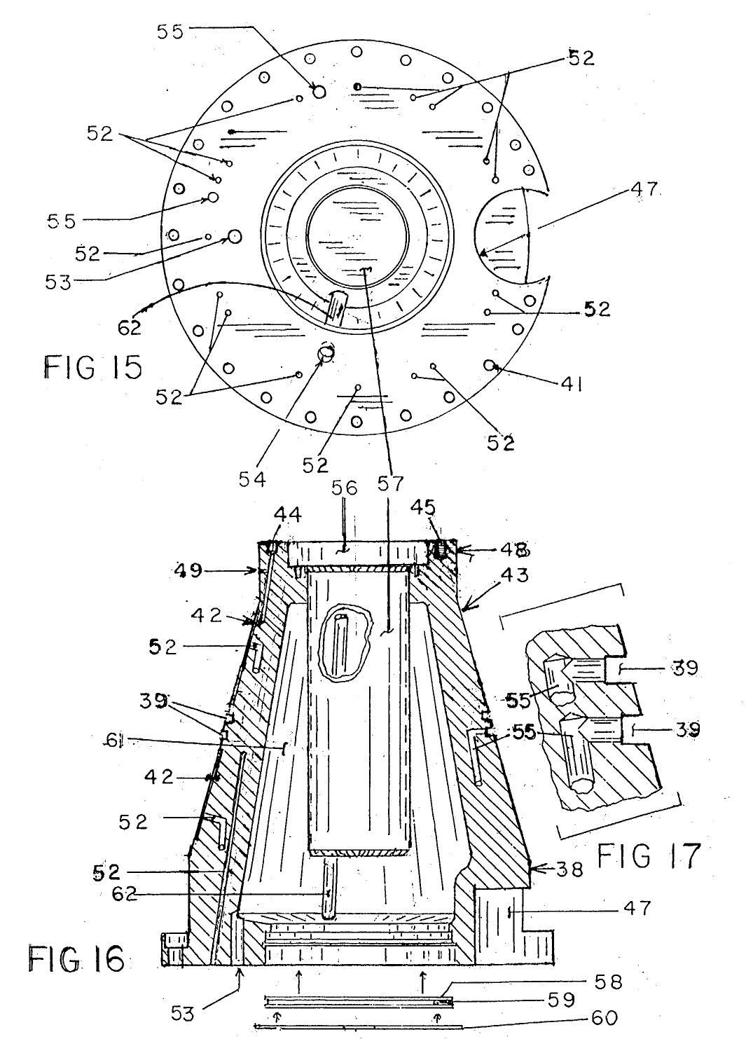

Page 6 FIGS. 11 &12 shows a spindle 38 that is force fit into recess 28 in member 10 by multiple cap screws. This construction accommodates both shearing and tipping forces that are huge in cone crushers, and because it is secured by cap screws and extracted by jack screws, this spindle is easy to service or be replaced by a new one even as the main frame remains in its working position. Other makes of cone crushers that use an embedded post shaft design have extreme difficulties to extract its shaft because of the very tight shrink or press fits extending through the full depth of their center member as such designs require, and such machines must be removed and be hauled to a repair shop if their post shaft must be replaced, all of which is very costly and time consuming. Except for the crusher design of this patent application all other cone type crushers whether post shafted or open for an eccentric mechanism have massive deep and wide annular hubs cast integral with radial arms and are recessed to accommodate a large bevel gear; these crushers must be built as such to resist deflecting cycling forces which cannot be totally contained; such construction adds substantially to the weight and costs of those machines. Such stresses and deflections do not transfer into our bearing design. The conical construction of our new concept design has an area at D dimension and a smaller area at D′; a cylindrical extension 48 of D′ diameter stabilizes an eccentric member 65 FIG. 18 page 8 when the hydrostatic oil film is too thick; the area difference of D minus D′ is substantial enough to provide an adequate hydrostatic thrust bearing when lube oil under pressure is ejected into flutes 42 and between bearing surfaces; the conical shape is large enough to eliminate diametral clamping by thermal shrinkage of metals of different coefficients of expansion, a severe problem with straight shafted crushers that use bronze bushings, because such bushings are heated by friction and try to expand against a much stronger steel or iron housing which is cooler and has a lower coefficient of expansion by a factor of about 60%; the results are the bushings are compressed, and when the crushers are shut down and bushings cool, they shrink to a smaller diameter and would clamp and seize to shafts they work against; the only way such crushers can cope with this phenomenon is to have excessive bearing clearances larger than the amount of shrinkage, but this in turn greatly reduces radial bearing area caused by diverging arcs and also causes inaccurate meshing of bevel gear drives, because the larger gear orbits true center which causes reverse end loading of the gear teeth during every 360° of rotation. Also constant shrinking and expanding of such bushings causes myriads of tiny cracks resembling a dried mud flat; the oil film is disrupted adversely affecting lubrication. Our design permits a nearly uniform oil film thickness through 360° because any differences of expansion between dissimilar metals is accommodated by the eccentric member lowering on the tapers if it expands, and if it shrinks, it climbs relative to the spindle on which it runs; while the eccentric loading may force a slight difference in oil film thickness to absolute true running, it is of no consequences, because our eccentric gear's teeth are parallel to its axis, vertical movements and meshing clearances accommodate any slight changes in depth of meshing. With its hydrostatic lubrication our bearing finds its bearing clearances in proportion to the imposed loads; injected oil is at a volume and pressures that prevents metal to metal contact; the results are running accuracies comparable to roller bearings, with very low friction and wear and not subject to cracking as with bushings nor fatigue spalling as are roller bearings, and original and maintenance costs are substantially less with our design. However, our hydrostatic bearings are not without fault; when operating unloaded a surplus of oil and varying viscosities can cause too thick an oil film which creates instability; the short cylinderical section, 48 FIG. 12, at the top portion of the spindle stabilizes the eccentric. FIG. 11′ is a plan view of the top of said spindle; 40 is a bolting flange; 41 are multiple countersunk holes for large cap screws; 43 is a conical super accurate smooth surface; 39 are two annular grooves that deliver lube oil to holes rotating with an eccentric member 65; said grooves are detailed in FIG. 13 with oil holes 55; tubes 50 with seals 51 transfer hydrostatic lube oil across a shimming space 163 between said spindle and a thrust bearing body 160 FIG. 31 Page 15; 49 are spaced apart annular grooves around extension 48 to supply hydrostatic lubrication between 48 and eccentric member 65;44 are smooth wall holes for tubes 50; 45 are threaded holes for retaining said thrust bearing; 47 is a chamber enclosing a spur gear. Surfaces 43 and 48 are machined to near zero tolerances and extremely smooth finishes; the fluting in the spindle is evenly spaced above and below the annular galleries 39. Oil volume is proportional between to the areas of the two zones, but is equalized to each flute by flow dividers; lube oil is supplied at whatever pressures and volume required; the varying loads of crushing vary the operating clearances, and the escape rate of oil at the ends of each bearing is similar to a variable valve, but at some point of clearance the escape rate reaches a limit that prevents further restrictions of closure because the pump pressures are always greater than crushing pressures, and volume is virtually constant. Our research has not revealed that a unidirectional conical hydrostatic bearing capable of coping with simultaneous radial and thrust loading has ever been used before in any kind of a machine. Hydrostatic lubrication to a thrust bearing positioned on top of said spindle is held in place by a slight press fit in bore 59 and by cap screws threaded into holes 45; tubes 50 sealed by O-rings 51 transfer lube oil across the space between the spindle and thrust bearing; gun drilled holes from the base of 38 to holes 44 transfer oil to tubes 50.

Page 7 FIG. 16 shows a vertically sectioned view of said spindle; 61 is an as cast hollow chamber with a inlet 53 designed to swirl incoming fluid, and an overflow outlet 62 designed to flow a heating/coolant fluid through said chamber thereby heating or cooling the actuating members of the machine as local weather temperatures and operating temperatures may require and to keep lube oil at the optimum viscosity range; heating or cooling from the inside out is more efficient, safer and simpler than flame heating the outside of the gyrating assembly as is done when other cone crushers are shut down between shifts in cold weather. Said fluid flows through a heating unit or through a fan cooled radiator or in extremely hot climates a chiller maybe needed before said fluid enters cavity 61; 52 are gun drilled holes to conduct lube oil to each designated flute 42 and to thrust bearing 160 some of which is shared with grooves 49; 56 is a precision bored recess for a tight fit with thrust bearing body 160; 57 is a fluid tight tubular member to enclose a hydraulic motor 167 page 15 FIG. 31; 56 is a precision bored recess to hold thrust bearing 160 in radial position; 58 is a solid cover with a sealing ring 59 and is retained in place by ring 60 that engages a groove; its purpose is to prevent heating/cooling fluid from mixing with lube oil; oil lines and h/c lines from members 11 connect to designated connections in member 10; holes 17 align to holes 52 and hole 33 aligns to hole 55 and hole 34 aligns to other hole 55; holes 52 and 55 carry lube oil; holes 53 and 54 carry water with antifreeze; all said holes are sealed with elastomer seals in recesses 16. Holes 52 deliver lube oil in equal volume to designated flutes in said spindle 38 to lift and lubricate eccentric 65 and to the thrust bearing less what goes to grooves 49; oil holes 55 deliver lube oil to annular grooves 39 that continually supply lube oil to holes 68 through eccentric member 65, page 8 FIGS. 18 and 20, to lubricate the conical bearing surface 81 of cone head 75 and matching surface of eccentric 65. Hole 53 delivers heating/ coolant fluid to chamber 61 in said spindle, and 62 withdraws it near the top of said chamber.

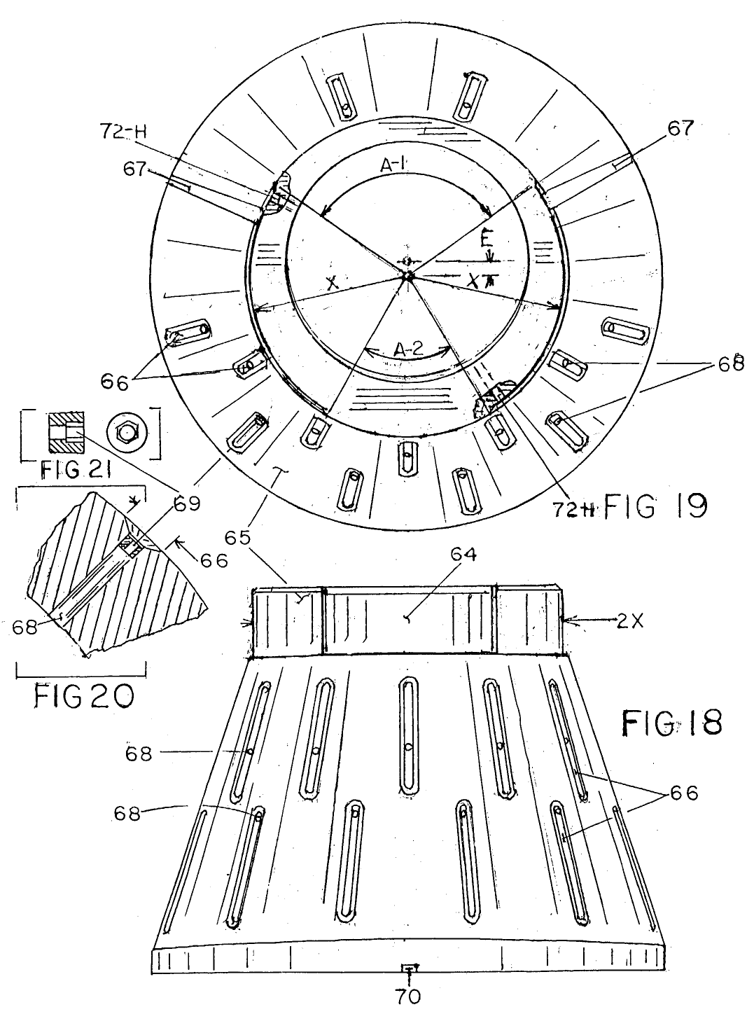

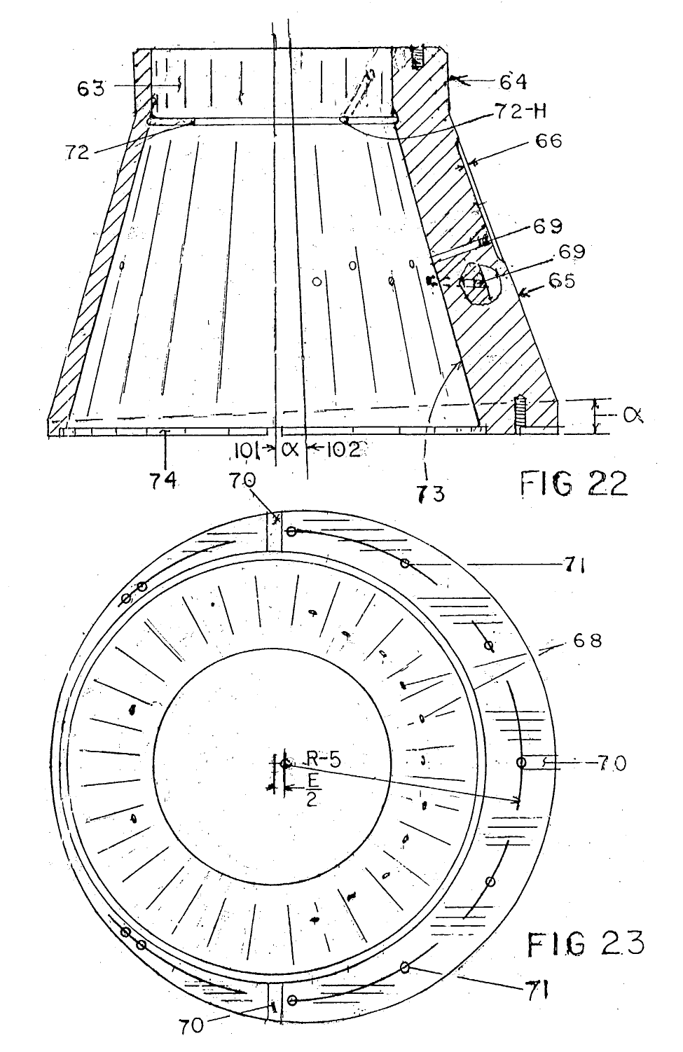

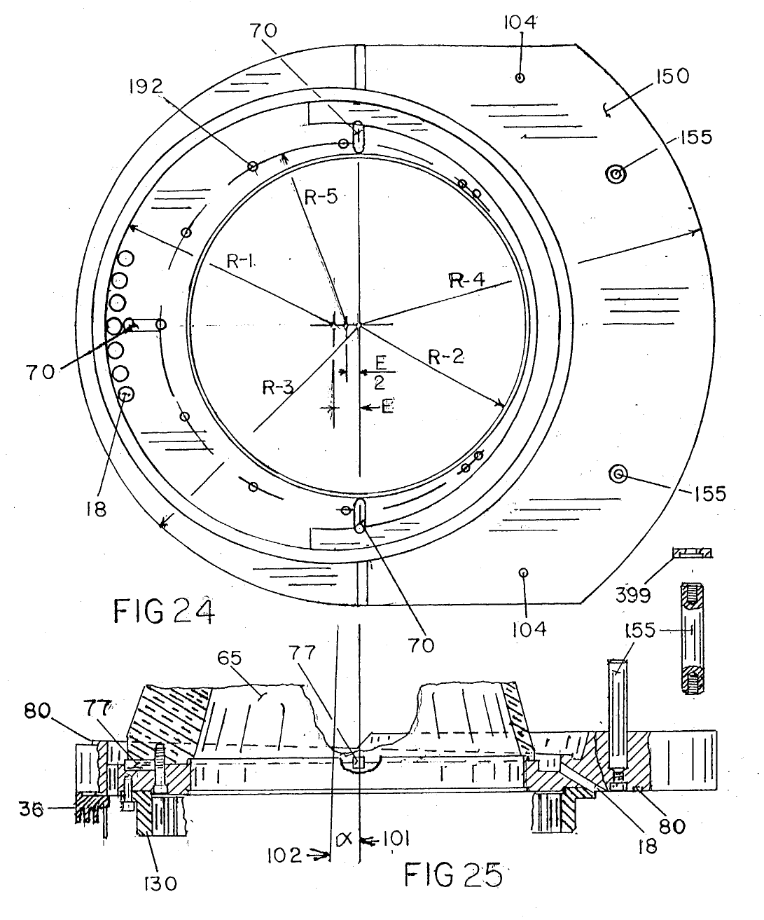

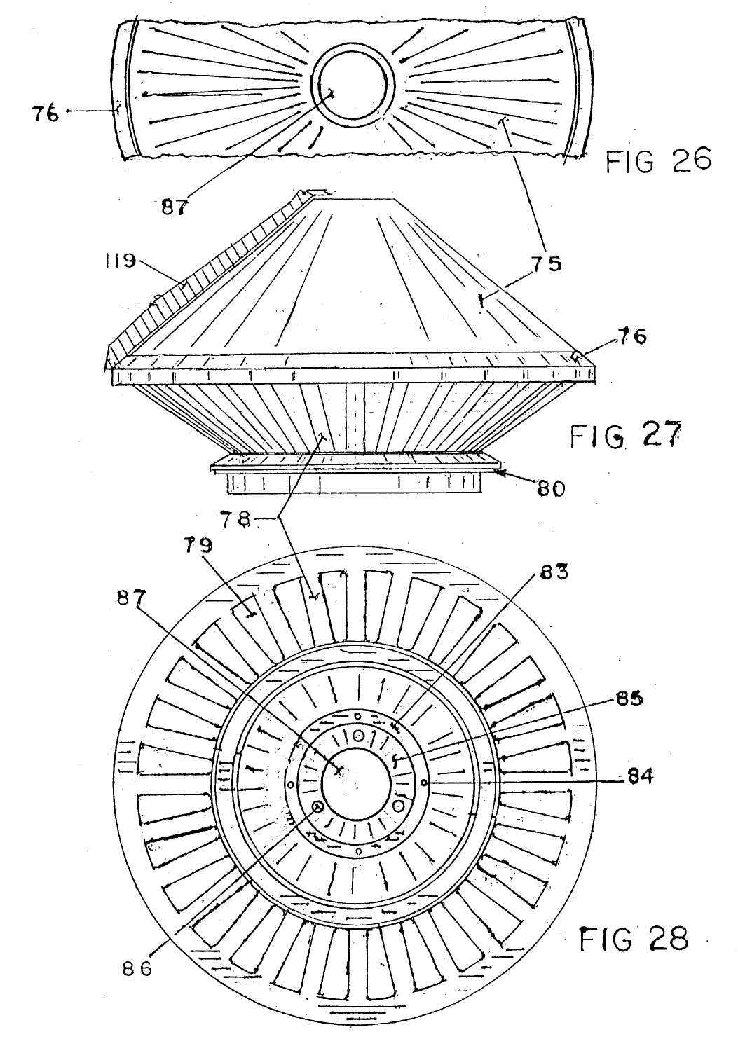

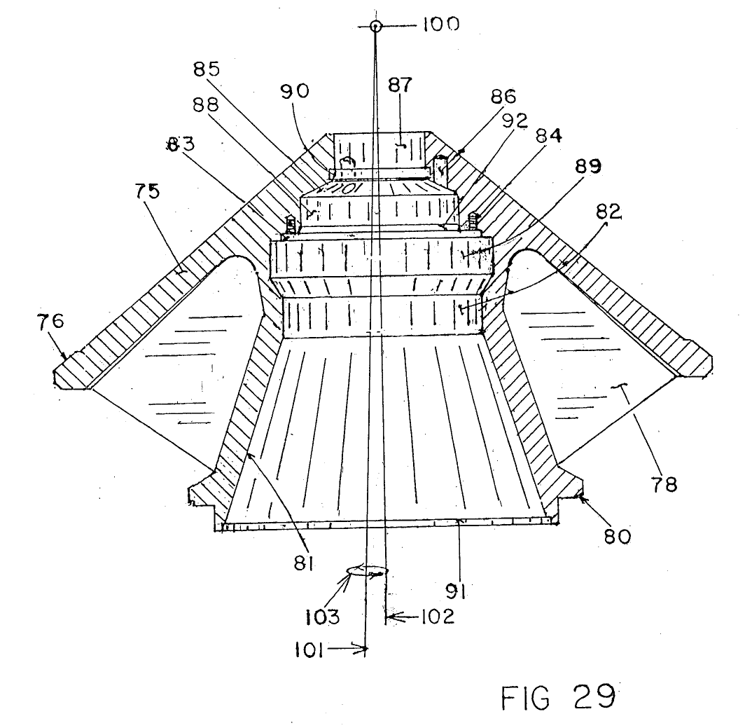

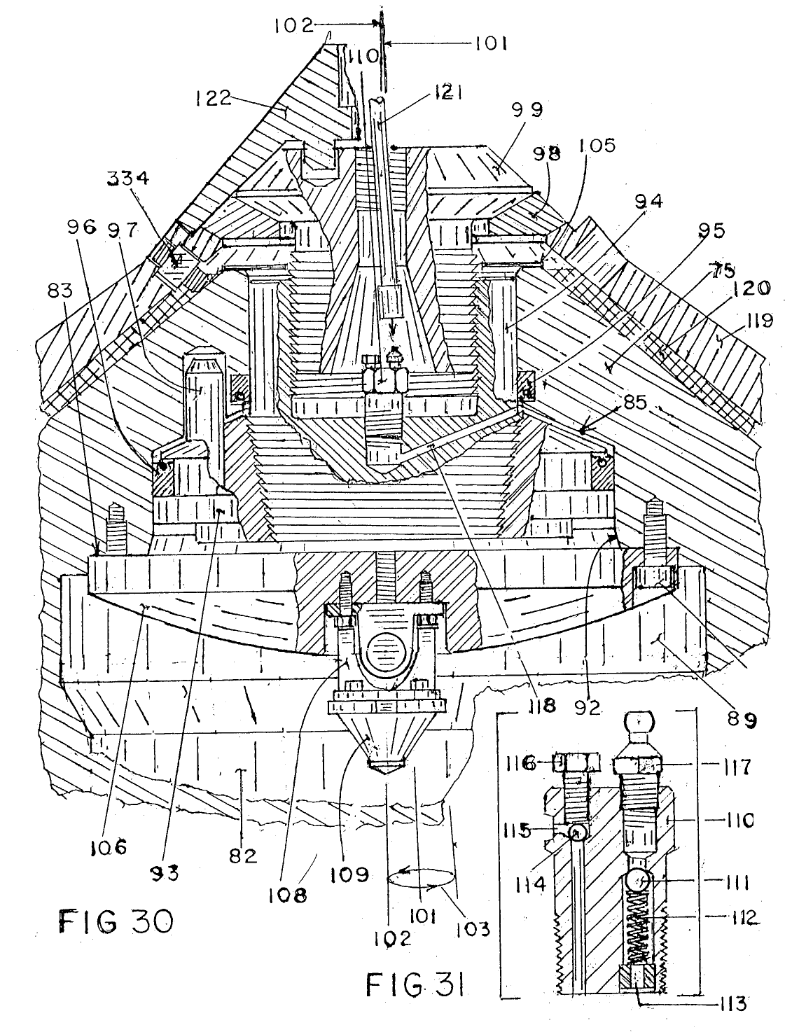

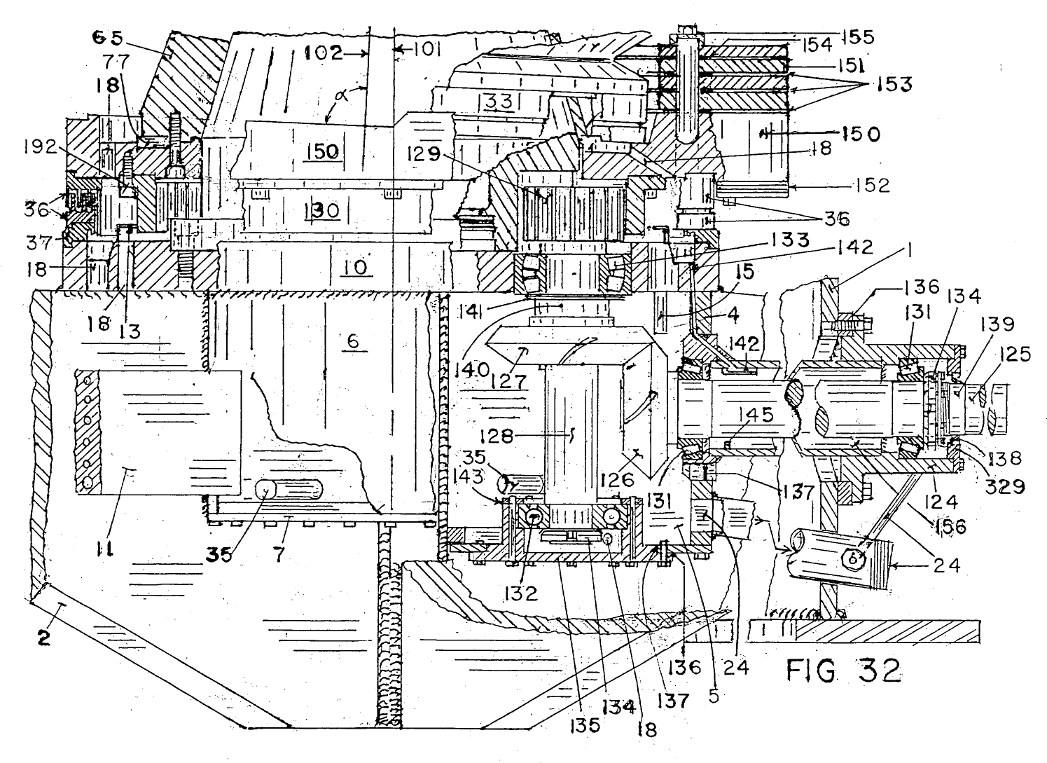

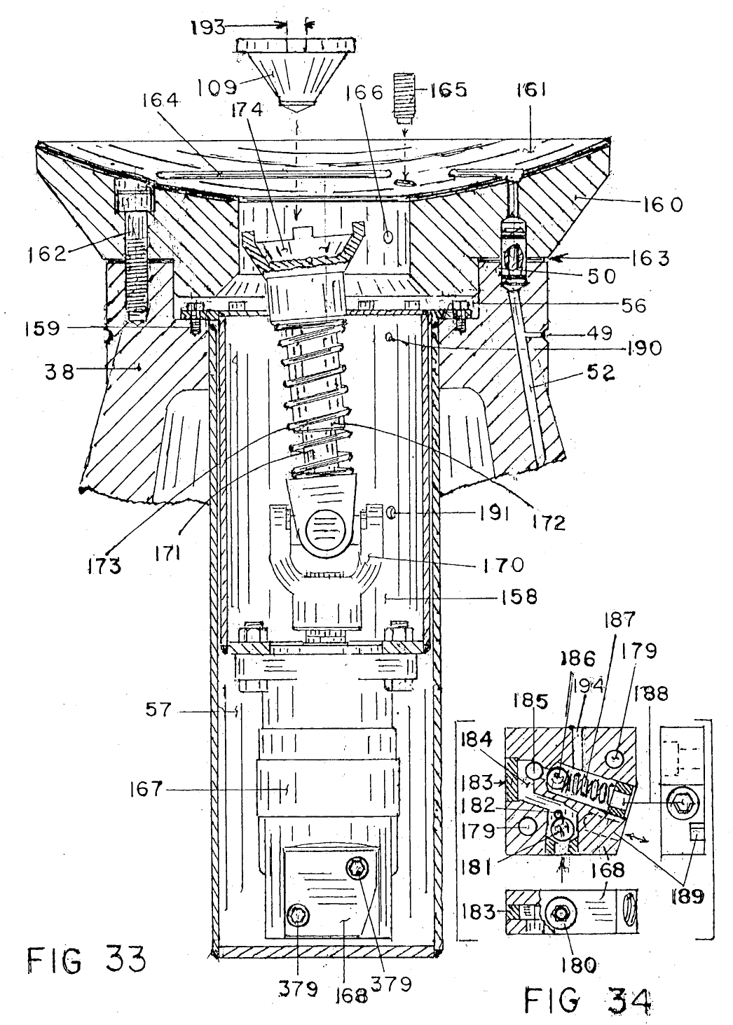

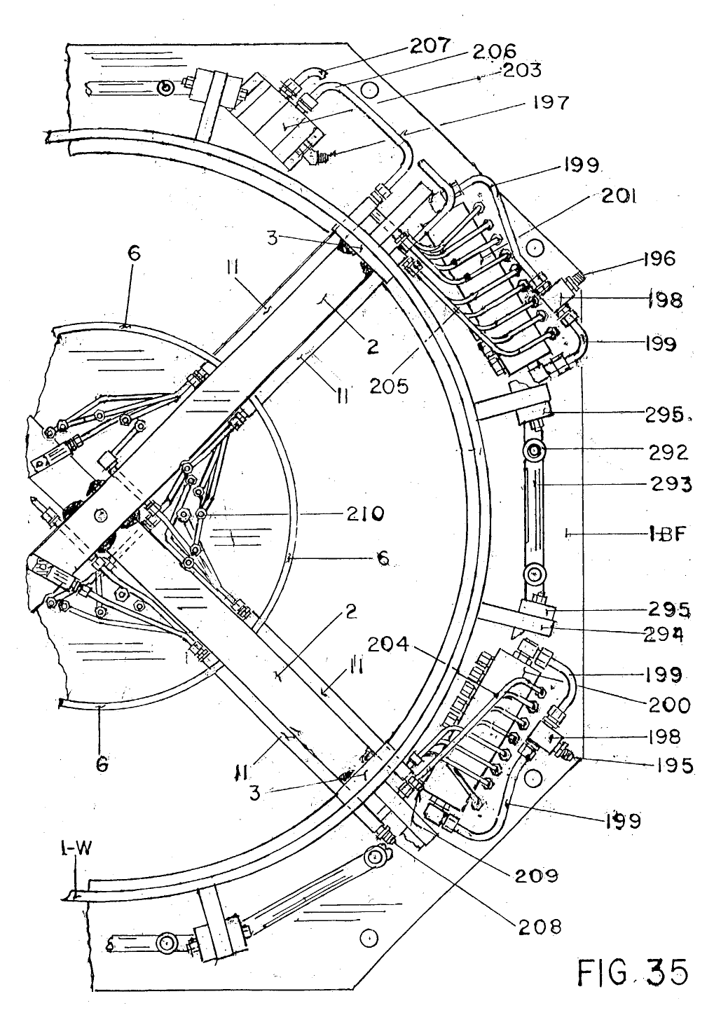

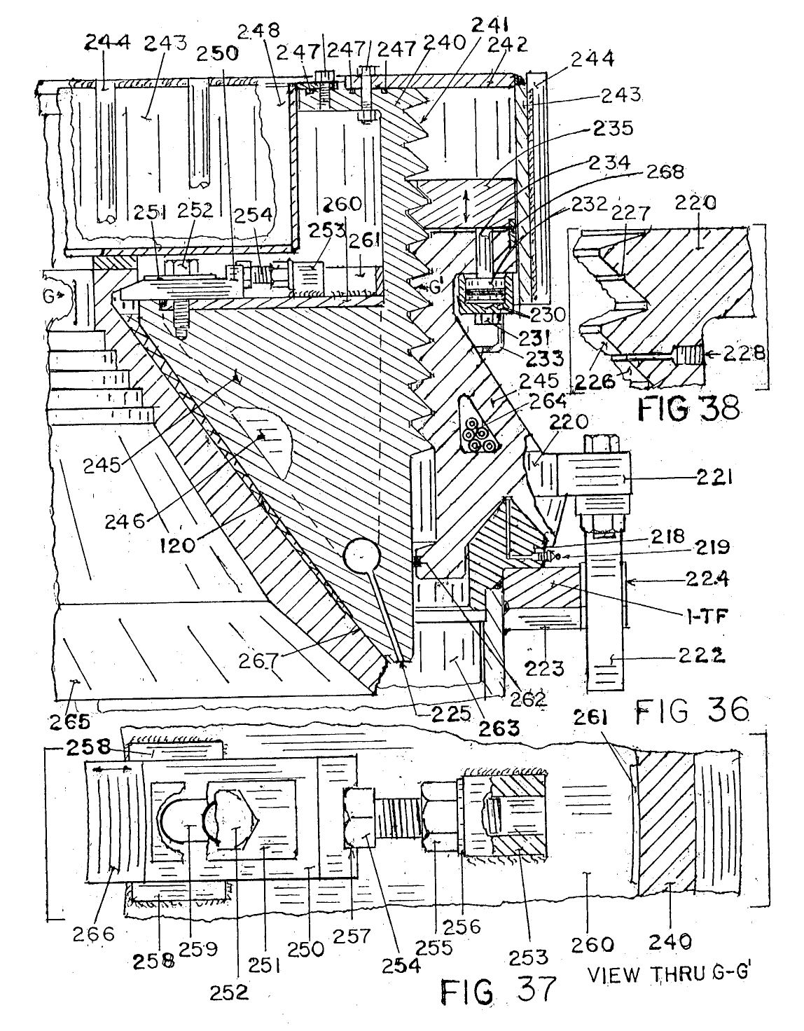

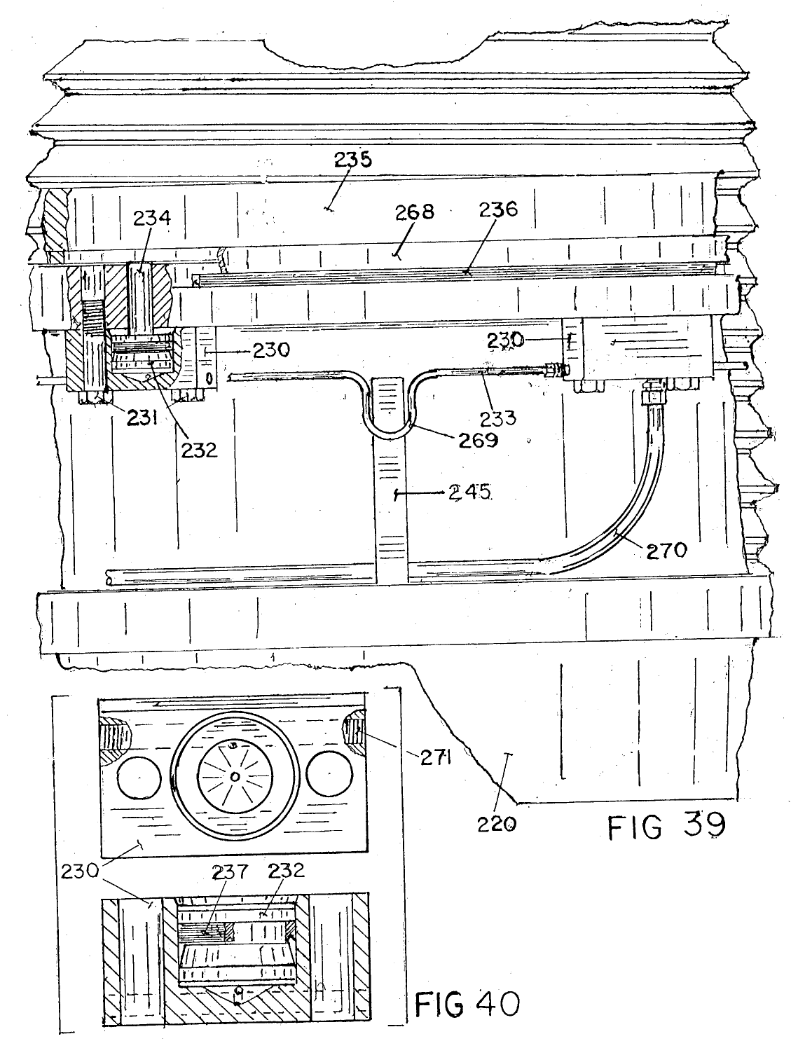

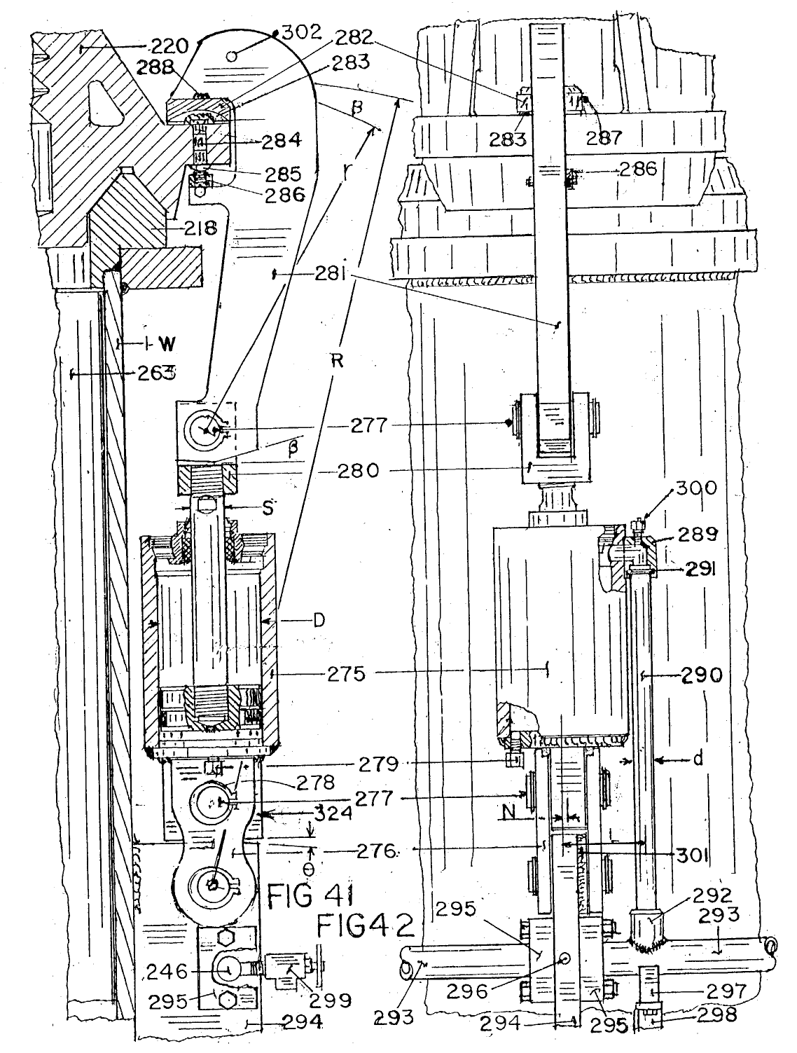

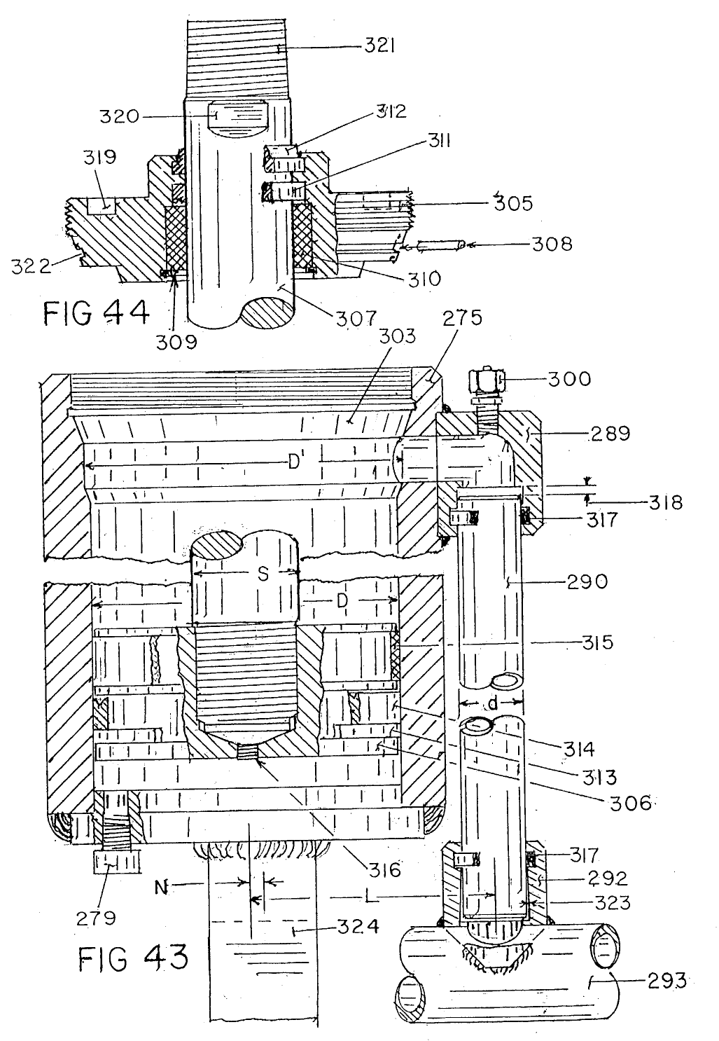

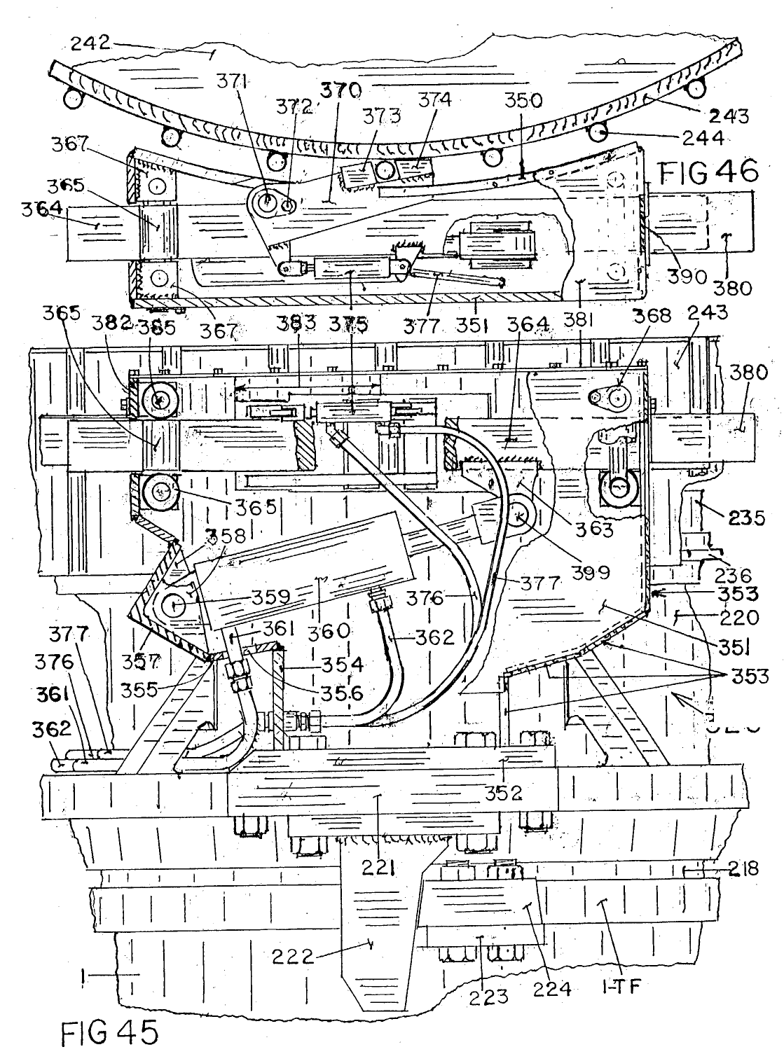

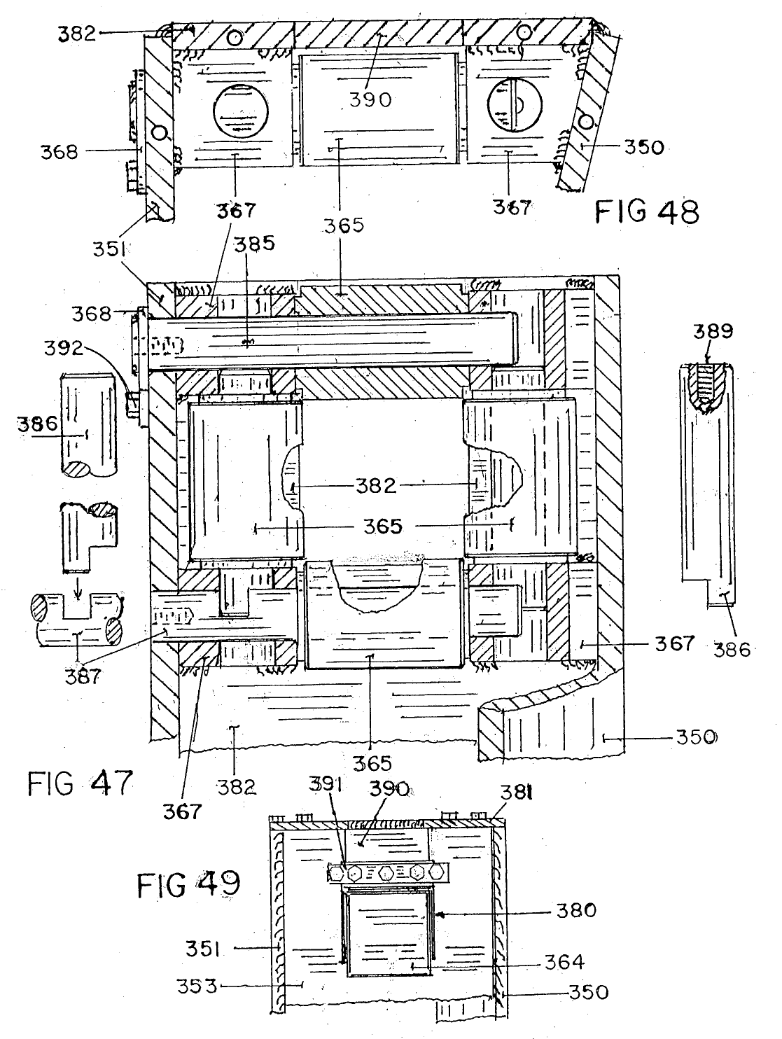

Page 8 FIGS. 18 and 19 and page 9 FIGS. 22 and 23 show the eccentric member 65 which is a non-ferrous bearing quality one piece casting; the taper of inner conical surface 73 is an exact match to the taper of spindle member 38; step bore 74 registers on a matching boss as shown in a partially assembled view on page 10 FIG. 49. Because it is not possible to use flow dividers to control oil flow to the outer bearing surface, we use nozzles 69 and vary the hole sizes to force the oil volume as best served; lube oil that ejects out of the top of the spindle and out of the thrust bearing 160 works again as it passes between the bearing surface of eccentric 65 and 81 of member 75 page 12 FIG. 27; open ended valleys 67 drain lube oil to prevent pressure build-up in the space above the eccentric; the eccentric does not contain bushings; it is a one piece member and has four bearing surfaces, two conical and two cylindrical; extension 48 has arc A-1 of less than 180 and a smaller arc A-2 that have just enough clearance for oil film; said arcs are equally centered to the plane of the eccentric; radii X form large arcs between arcs A-1 and A-2 and have substantially shorter radii which form very large clearances that can absorb thermal expansion by bulging radially enough to eliminated clamping; the eccentric metal is flexible enough to allow said bulging without excessive bearing pressures on arcs A-1 and A-2. The conical angles of FIG. 18, and cone head, FIG. 24 are held concentric to their centerlines as is a spherical thrust bearing 106 to said spindle. FIG. 28 page 13 and 160 FIG. 31 page 15

Page 9 FIGS. 22 and 23, keyways 70 and keys 77, page 10 FIG. 49, transfer driving torque and accommodate thermal expansion and contraction without distorting eccentric member 65; cap screws holding 65 to an eccentric drive plate 150, page 10 FIGS. 48 and 49 have sufficient clearances in holes 192 to accommodate thermal movements of said eccentric 74 centers eccentric 65 on its drive plate 150. 73 is the inner conical surface that rotates about spindle member 38 and concentric to centerline 101 as does cylinderical bore 63. 72 is a annular groove that accepts hydrostatic oil that escapes from the top of the taper 73 and funnels the oil outward through holes 72-H which in turn discharge said oil just ahead of arcs A-1 and A-2 for additional lubrication thereby preventing eccentric 65 from acting like a piston.

Page 10 FIGS. 48 and 49 as explained in Brief Description of The Drawings, these FIG numbers are not in the best sequence. Eccentric drive plate 150 is attached to said eccentric 65 by cap screws on holes drilled on R-5 radius and is driven by keys 77; radii R-2, R-3, and R-4 are centered on the main centerline of the crusher; R-1 is a varying radius from centerline 102 that reaches its maximum at the contact plane between eccentric 65 and eccentric drive plate 150, 130 is an internal tooth gear that drives the eccentric member; it is attached to the underside of 150 by multiple cap screws and is shouldered to run concentric to main centerline 101; 18 are oil drains that flow lube oil back to a reservoir. The combined weights of the cone head and mantle, 119 FIG. 24 page 11, establish a c.g. that when gyrating eccentrically creates centripetal forces that must be neutralized by counterweighting; the extended R-4 radius provides about half the required counterbalance, and extra weight required is provided by weights 51 FIG. 3 and fine tuned by weights 152 (see page 14 FIG. 30) that can be changed without removing the cone head; an air space 153 is provided between each counterweight plate by washers 154 so crusher dust can be ejected and minimize any build-up of dust against the inside radii of said plates. Pins 155 embedded in holes with clamping washers 399 plus long cap screws in threaded holes 72 hold all upper counterweights against centrifugal forces. The spinning counterweights generate considerable air turbulence within the open chamber below the cone head; circular shields, 336 page 3 FIG. 3, direct air flow upward and downward rather than radial; this reduces rock dust erosion of the counterweights and directs some air flow into cavities 79 of said cone head member thereby producing a cooling effect to it. 80 is a positive angled boss to retain seal 36 by shrink fit

Page 11 FIGS. 24 shows a vertical view of the exterior configuration of the cone head 75, this is the member that is gyrated by the eccentric and performs the crushing action; 119 is a wear mantle that is firmly clamped to said cone head (see page 13 FIG. 28) and prevents wear on the cone head itself; depending on the abrasive characteristics of the rock being crushed, the wear life of 119 can be from a few days to years. Because of the extreme difficulty to machine the wear material, usually manganese steel, we choose to employ a fairly narrow machined surface 76 to support the mantle at its rim this leaves a space inward that is filled with a liquid backing that hardens in a short time; 80 is a boss for retaining a sealing ring; FIG. 25 is a plan view of the bottom: 78 are struts that transfer crushing forces into the conical wall of bearing surface 81 FIG. 27; 79 are spaces between said struts to reduce weight; 84 are threaded holes to retain a conical thrust bearing; 86 are two or more holes evenly spaced ,we prefer using three, that lock a piston from rotating; 87 is a precision bore that serves as a cylinder; FIG. 26 is a segmented plan view of the top.

Page 12 FIG. 27 shows a vertical sectioned view of said cone head; 81 is an extremely accurate conical and smooth bearing surface that journals on the eccentric 65; 91 is an extension of the cone head that serves as an oil deflecter and a protection of surface 81; 82 is a smooth bore cylindrical bearing surface; 89 provides gyrating space around thrust bearing 160; 83 is a precision recess to retain 106 the convex half of thrust bearing 160 page, 13 FIG. 28; 92 is a short steep taper to assist the installation of a large elastomer seal ring; 88 is a smooth cylindrical bore in which a piston slides; 85 is a conical surface to match the top conical surface of a piston; 90 is a seal ring groove and 87 is a smooth bore for a piston extension to slide.

Page 13 FIG. 28 details the assembly and functions of parts that retain said mantle 119 and comprise one of the most important elements of our invention and claims. Piston 93 combines a mild steel disk having a steep tapered female buttress thread into which a very high strength steel member 94 is assembled with an anaerobic sealant and tightened to refusal; 94 has an internal thread that accepts the male thread of cap screw 99 with a free fit; the wall thickness of 94 provides more tensile strength than 99 in case a breakage should occur; 94 has a valve assembly 110 threaded into the recessed face of its threaded bore; a hole 118 is angle drilled from above the first thread of its taper into the hole containing 110. Seals 95 and 96 provide leak proof retention of high viscosity oil that is pumped into the space between said seals. When installing a new mantle it is lifted by a crane or other means and preferably using our safe lift device (U.S. Pat. No. 5,323,976) and placed over and centered on cone head 75; said lifting device is removed and conical washer 98 is positioned; large cap screw 99 having a double conical head is threaded into 94 and hand tightened to pull piston to face to face contact of its angled surface. FIG. 29 is an enlarge sectioned view of 110; an oil pump extension 121 engages fitting 117 through a threaded hole in 99; pumped oil flows past ball valve 111 and out hollow hex screw 113; cap screw 116 is slightly loose until all air is ejected, then it is tightened forcing ball valve 114 to be firmly seated; oil is then pumped into 117 until the piston is pulling between 200K and 800K lb.s depending on the size of the crusher; these forces are easily obtained with our new system but extremely difficult with sledging against a wrench to turn the screw or nut as in all other designs. During crushing the mantles on every kind of gyrating cone crushers tend expand due to pressures of crushing; this phenomenon causes the mantle to creep relative its cone head in the direction the cone head gyrates; washer 98 and cap screw 99 are constructed to turn with the mantle to insure that the mantle stays tight against the surface 76; this results in the cap screw or nut, whichever is used, becoming so tight that it is impossible to unscrew; consequently a cutting torch is necessary to relieve the enormous pressure and friction; either a torch ring is used or the washer is cut which then another must be purchased or the mantle is cut with an arc-air because manganese steel cannot be cut with gas torches; these are time consuming and costly methods that are unavoidable until now To prevent the piston from turning with its cap screw in our new concept we use pins 97 pressed into the piston and engaging holes 86; when mantle changing time comes, wear cap 122 that has been held in place by a cap screw 333 is removed, and a small socket wrench on an extension handle opens screw 116; oil pressure is released through port 115; the cap screw 99 can be unscrewed with a hand wrench; the work is easy; the time is fast, and nothing has been destroyed. However, nothing is fool proof, and should the hydraulic oil escape from its containment the cap screw will draw the piston tightly against surface 85 like other cone crushers; in that event washer 98 can serve as a torch ring; copper washer 105 prevents a cutting torch flame from damaging the surface of the cone head. Nut 334 was left in place at time of assembly to enable our safe lifting device to be reattached and used to lift off the worn mantle; a setscrew that was threaded into said nut at the time of installing a new mantle to protect the nut from filling with rock dust must be removed first. Other members of FIG. 28 are thrust bearing 106 having a spherical radius centered at vertex 100 and is retained in recess 83 by cap screws 107. A universal joint 108 in a recess is held by cap screws; 109 is one half of a jaw clutch fastened to said joint 108; its conical projection is to guide said clutch into its mating half which is a blind assembly in an inaccessible position.

Page 14 FIG. 30 shows vertical sectioned layout of our double reduction gear train; 125 is the power input pinion shaft; it is journalled in tapered roller bearings 131 in tubular housing 156; 134 is mechanism to adjust said bearings to correct operating clearance; 138 is a sealing means against entry of contaminants and escape of lube oil; 139 is a replacible wear band to protect the shaft from a rubbing seal; 329 is a cover plate retaining said seal; 126 is a spiral bevel pinion gear keyed and shrunk fit to said shaft; 137 is elastomer seal ring to seal against oil loss; 142 is a passage way to deliver lube oil to outer bearing 131 in combination with dike 145; a small drain tube drains this oil to main oil drain 24; 136 are shims for adjusting pinion gear mesh with mating gear 127; 128 is a vertical shaft with spur gear 129 made integral; roller bearing 133, flinger 141, and spacer collar 140 position gear 127 to an exact position from gear 129 and ball bearing 132; by positioning bevel gear 127 above bevel pinion gear 126 the torque pressure on 127 and counter torque on spur gear 129 greatly reduces the loading on bearings 133 and 132; the radial loading on bearing 131 adjacent to gear 126 would be the same regardless of rotation direction; bearing 132 is capable of handling thrust loads in either direction as well as radial loads; it is retained in fixed position in housing 135 by retaining plate 143 and cap screws; lock washer and nut 134 hold 132 firmly against the shoulder of shaft 128; 136 are adjusting shims; 18 is an oil drain; 35 are drain port in beams 2; this system insures obtaining and maintaining proper bevel gear meshing; spur gear 129 does not require meshing adjustment. Internal tooth gear 130 is attached to eccentric drive plate 150 which in turn is attached to eccentric 65 as previously shown in FIG. 49; when lube oil enters between said eccentric and spindle 38, the eccentric assembly lifts to a level that balances the oil escape rate to the weight of the assembly; oil viscosity is also a factor; when the pressures of crushing begin, the assembly is forced down to a thin oil film; total variations of vertical movement between running empty to maximum loading may reach two millimeters; straight tooth gears accommodate these variations. FIG. 30 shows labyrinth seals 36, seal spacer 37, counterweights 151, air spaces 153, spacers 154, and fine tuning balancing weights 152. An important advantage of this design is its elimination of the massive gear well of other cone crushers and permits the use of full depth crossbeams for maximum strength with a substantial reduction in weight and costs.

Page 15 FIG. 22 is detailed vertical sectioned view of the thrust bearing 160 and cone head braking mechanism; 161 is an over-lay of bronze welded to steel member 160; however, such over-lay could be other bearing quality metals e.g. Babbitt or hard plastics. 164 are annular grooves spaced apart by closed ends; tubes 50 with sealing rings transfer hydrostatic lube oil across a shimming gap between spindle 38 and member 160; cap screws 162 pull member 160 into a tight fit in recess 56 and to hold same; jack screws 165 are used in adjusting shims 163 and to extract 160. The thrust bearing is positioned vertically to support the cone head a predetermined distance above the eccentric; this distance is the sum of the sines of the desired oil film thickness of the spindle angle and the outer angle of the eccentric. The lubrication of the cone head conical surface 81 is mostly hydrodynamic, but is assisted with some hydrostatic lift. When cone crushers are running idle (not crushing), the cone head will tend to spin with the eccentric because of frictional drag, this undesirable; Louis Johnson, co-patentee of this application, invented the first head brake for cone crushers, U.S. Pat. No. 3,207,449, in which he used an over-running clutch, and which others have copied; the problem with such clutches is they cannot endure shock reversing impact nor torque loads above their capacity; when this happens they rupture or shearing devices are used to prevent rupture; such clutches are expensive to buy and more costly to replace. Our new concept uses a hydraulic motor 167 with a valving mechanism that is free to turn in one direction but resist turning in the opposite; an enlarge view FIG. 32 details its operation; when crushing the cone head turns slowly retrograde to the eccentric and must not be restrained. To allow turning freely oil is drawn in through valve seat 180 and around ball valve 181; a stop pin 182 limits the travel of 181; oil flows through passage way 184 and into the motor through port 185 and out the motor through port 189, but when the motor is forced to turn opposite, ball valve 181 closes, and oil is then drawn in through port 189 and to escape must force ball valve 186 to open which compresses spring 187; by-pass oil can be vented through hole 194 or through hollow hex screw 188 which is drilled to exhaust oil; the screw adjusts the spring force to just enough resistance to override head drag, but not enough to permit harm to co-operative parts if somehow the cone head adheres to the eccentric; to machine passage way 184 it is necessary to have an opening which is closed later with weldment 183; cap screws 379 hold valve body 168 oil tight to motor's porting face. At assembly of cone head to the thrust bearing and eccentric which is a blind assembling procedure, jaw clutch cone 109 automatically finds alignment to female cone 174 and slides into it, but it is unlikely that the projecting lugs of 174 will find slots 193 in cone 109 initially in which case spring 173 yields and spline 172 slides on 171 as needed; after the cone head is fully in place, and the lube oil pump is started, the head is easily turned by hand, thereby finding alignment where spring 173 will push the jaw clutch to full engagement; the universal joints convert eccentric rotation to inline rotation; The motor is suspended by tubular member 158 which is torque restrained by cap screws 159; fluid tight enclosure 57 prevents intrusion of h/c fluid; lube oil escaping inward from said thrust bearing 160 fills the enclosure 57 and motor mount 158 through port 191 to the level of port 166; any air in the enclosure vents out hole 190 and 166; any excessive pressure is relieved through hole 166 and valleys 67.

Page 16 FIG. 33 shows how the lube oil flows in our hydrostatic design; 200 is a flow divider that apportions oil equally to the flutes 42 in the lower zone of spindle 38; said oil flows out of 200 into tubes 204, into members 11 on each side of beam 2, and into three chambers formed by members 6, 10, and 20; members 11 are flat bars of steel of ample sizes to protect oil passage ways drilled through them from the ravages of falling rock; wear caps 335, FIG. 3, further protect members 11 and beams 2. Flow divider 201 equally apportions oil to the upper zone of said spindle and also to the thrust bearing 160 through lines 205; proportionator 203 ratios the oil to annular grooves 39 through lines 206, and 207; both lines deliver their oil to their pair of members 11; the lower groove gets the larger portion of oil from 203 because it supplies a larger bearing area; multiple lines within said chambers conduct their portions to specific connections in member 10; return oil drains through holes 18 in 10 into all four chambers, then through ports 35 in beams 2 and out exit port 24 to a tank not shown; lube oil drawn from said tank passes through filters and heat exchangers before reentering the machine; a three chambered pump supplies oil to connectors 195, 196, and 197. Heating/coolant fluid normally water and antifreeze mix enters through 208 and out 209 after circulating within chamber 61; said fluid also passes through heat exchangers as it circulates through the system. Numbers 292, 293, 295 are members of the safety relief system page 19.

Page 17 FIGS. 34 & 36: A machine that crushes rock by compression has a stationary member and a moving member to form a squeezing force; in a cone crusher the stationary member is called a bowl which in this patent application is number 240; multiple gussets 245 brace the conical wall of 240; 246 are open spaces between said gussets. To protect the bowl from wear a bowl liner 265, a casting of wear resistant metal, is positioned in the bowl where it seats on conical surface 267; to retain it in place we have designed a sliding wedging system using three or more wedges 250 evenly spaced circumferentially and to bear against an inverted conical flange machined at the top of said liner; thrust bolts 254 are locked from turning by vertical slots 257 as thrust wedges 250 are forced inward as nuts 255 are turned; blocks 253 absorbs the thrust, and washers 256 protect 253 from wear of turning said nuts; cap screws 252 and cover plates 251 prevent wedges from tipping and are tightened after all wedges are tight; slots 259 provide travel of wedges relative to cap screws 252; 258 are guides to prevent skewing of wedges; 266 is a wedging ramp with a conical radius to match liner's; 120 is backing material usually epoxy but could be zinc which are poured in their liquid state but soon turn to solids. Not shown are pouring spouts built in to save workmen from making them every time new liners are installed. 248 is a hopper to keep rock away from damaging wedging system members. A crusher must have a means of adjusting for whatever size product maybe required and to compensate for wear of liners; Most gyrating cone crushers use a threaded means to achieve that; a problem with threads is potential galling between two similar metals; to cope with this problem we provide a small groove on the loaded face of the female thread 227 FIG. 35 in bowl nut 220 and a means of injecting special greases either by hand pumps or automatic lubricators through multiple places 228; the start and end of said groove is blocked as well as intermittently between said 228s; a lock nut 235 is restrained from turning by means of three equally spaced pins, 330 FIG. 3, but can move vertical a short distance; alter an adjustment is made, hydraulic fluid under pressure forces multiple pistons 232 against thrust rods 234 which causes said lock nut to lift bowl 240 and hold it firmly against thread flank 226; said pressure is maintained between adjustments in hoses 270, one of which is shown in FIG. 37 page 18; a P.O. check valve at the control, not shown, retains the constant pressure between the pressure source and cylinders 230. Adjustment ring 243 is bolted to the top flange of bowl 220, and it has vertical lugs 244 evenly spaced around its perimeter. Page 21 FIGS. 43 and 44 detail the power adjusting system. V-ring 218 has a means of receiving injected grease to minimize fretting between it and bowl nut 220. 263 is a replacible abrasion resistant liner bolted to the inside of wall 1-W to protect said wall from erosion of the crushed rock. 245 are bracing gussets with openings 264; hydraulic hoses for the adjusting means are passed through these openings.

Page 18 FIGS. 37 & 38 show in enlarged detail our bowl nut locking system; a gap between band 268 and a shoulder on the top flange of bowl nut 220 provides space for a dust excluder 236; multiple cylinders 230 are clamped to the underside of said flange by cap screws 231 that are sized to cope with whatever pressures are imposed on pistons 232; high pressure seals 237 retain pressurized oil, but if any leakage develops each cylinder is easily removed, seals replaced, and cylinders re-attached; rectangular cylinder bodies are through drilled and threaded 271 to receive connector fittings, and all are connected in series by lines 233 either tubing or hoses; small holes from cylinder heads to holes 271 feed oil in or out of said cylinders; two hoses 270 approximately 180 deg. apart conduct hydraulic oil to and from all cylinders for balanced oil flow between a T connector and one hose to a P.O. check valve.

Page 19 FIGS. 39 & 40 and Page 20 FIGS. 41 & 42 combined show our new concept relief system; FIG. 39 is a tangental view of one of several assemblies; 294 is an anchor plate that resists the pulling force of cylinder 275; links 276 and pins 277 couple said cylinder to 294; 278 are retaining rings to keep pins 277 in place; 280 is a clevis joining piston rod 307 to hook like member 281; 282 is a concave disk centered on the line of tension and lightly welded to 281 by welds 288; 282 centers on convex disk 283 that has either a projection or a recess and pin that centers it on holes 284 all equal-distant from the center-line of the bowl nut 220 and are usually equally spaced circumferentially; block 286 contains a headless screw and rests on an inward projection of 281 and is held in place by a small bolt; a spherical head shoulder pin 285 is secured in the lower end of hole 284; screws in 286 are adjusted to barely touch 285; this system prevents hooks 281 from disengaging pads 283 when the system is not pressurized. When the system is pressurized, entrained air is bled out by valve 300, then each unit pulls 220 downward onto V-ring 218 with great force. During normal rock crushing tight contact is maintained between 220 and 218, but should a non crushable object enter the crushing chamber the forces generated will lift the bowl assembly and override the gas pressures in the accumulators as oil flows from the cylinders 275 through tubes 290 and 293 and into the accumulators; this compresses the gas (Nitrogen) somewhat, but because of the large size accumulators we use, pressure increases are not excessive. This system prevents disastrous damage to the crusher. Louis Johnson, a co-applicant to this patent application, was granted a U.S. Pat. No. 3,118,623 for a similar but less sophisticated system. As explained earlier our new system allows the assembly to tilt outward on radius R or just the hooks on radius r; to do this blocks 286 are removed; valve 299 is opened, and hydraulic hoses with quick couplings are uncoupled; either a lever is placed under the projections supporting 286 and 281s are pried off of pads 283, or a special tool using hole 302 is used; all this takes less than ten minutes for two men; three lifting cables are attached to brackets 342 and to a crane hook, and within ten more minutes the bowl assembly is resting on the ground on its downward extension arms 222. The benefits are extremely rapid and easy removal of the bowl assembly for changing wear liners or quick access to the interior of the gyrating mechanisms, and most important huge cost savings to its owner. FIG. 40 is a radial view; members 300, 289, 291, 290, and 292 are better shown in detail on page 20 FIGS. 41 &42. Manifold tubes 293 will turn within header plates 295; when 275 is tilted outward; tubes 290 slides within connectors 289 and 292 because 290 is centered on 293 which is a longer radius than radius R; this requires space 318 to allow sufficient slip distance; because 290 can slip, it acts as a piston which tends to tip cylinder 275 opposite to 290 thereby putting side pressure on bushing 310 and bending forces on piston rod 307; to neutralize this force we use a formula that uses the area of D less the area of S divided into the area of d multiplied by L equals N where L is the centerline distance of 275 and 290, and then pads 301 are made twice N and are welded to one side of anchor plates; 297 is a saddle block that must be removed so 293 can be lowered far enough to extract 290 from its slip connectors; when in place it and column 298 support the thrust of 290. In FIG. 41300 is an air bleed; 289 is fused to 275; 317 are high pressure elastomer seals; 323 is a small angle in 289 and 292 to accommodate both ends of 290 from binding in 289 and 292; 316 is a pipe plug to release air when inserting ram 307 into piston 306 when the threads are coated with an anaerobic locking fluid; 316 is then tightened; 313 is a plastic back-up ring; 314 is a high pressure elastomer seal; 315 is a nonmetallic wear band, 289 is a right angle connection fused to cylinder 275. In FIG. 42308 is a threaded cylinder head; seal ring 308 is set in groove 322; high pressure seal 311 is installed; bushing 310 is inserted and retaining ring 309 is inserted; rod wiper 312 is inserted; the cylinder head assembly is slid onto ram 307; the piston and ram assembly is inserted into cylinder bore D; D′ allows seal to pass oil entry port without being damaged and also to facilitate oil flow if piston is ever pulled to touching the cylinder head; cylinder head 305 is then screwed into 275 and tighten to refusal on tapers; a pin wrench engages holes 319. 321 are taper threads to bind tightly with the tapered threads in clevis 280 which is next installed; the tops of links 276 are machined 90 deg. to center lines of pins 277 and stepped to clear welds this forces 275 to pivot at the lower pin hole of links 276; said links could be eliminated by having two members 324 spaced apart and welded to the cylinder head, but the link design gives more flexibility. Hook- like members 281 are pinned to clevis 280; a hole 302 is drilled in 281 on or near the center line of gravity of the assembly; this provides a simple means for lifting by mechanical means each assembly into working position, and the use of a tool to enable one person to swing the hooks outward and return to operating positions.

Page 21 FIGS. 43&44: 326 is one of two power adjusters set 1800 apart that rotate member 243. 243 is bolted to a threaded bowl member 240 that when turned changes the crusher's setting to obtain desired product sizes; also shown are 222 and 224 that is bolted to platform 223 which is welded to 1=TF these multiple anti-rotation stops restrain bowl nut 220 from moving circumferentially. Another advantage of our depending arms design is a ready made means of supporting the removable frame at a convenient height when it is set on the ground or floor; other crusher designs require wood blocking which can be slow and troublesome. The adjusting mechanisms work in parallel as follows: a control console contains an electric motor driving a high pressure hydraulic pump powers all the adjustment cylinders and the hydraulic oil to the relief system; spool valves manually controlled or remotely controlled by solinoid valves direct hydraulic oil in sequence. To close the setting the pawls 370 are swung open by cylinder units 375 and rams 364 are pulled to the left by cylinder units 360 to stopped positions; valves direct oil to 375 which pulls pawls 370 which swing inward gripping two opposed lugs 244 between grippers 373 and 374; lock nut 235 is depressurized and ram units 360 pushes 364s thereby turning bowl 240 one chordal length between lugs; as 240 turns, pawls 370 are forced to move outward and inward slightly but enough to cause harmful pressures, this is alleviated by a small accumulator in series with 370s. At the end of the stroke of 360s the locknut is pressurized to hold the bowl to the new position; if desired to move more than one lug, the sequence is repeated as many times as necessary; to open the setting the sequence is same except the starting position has rams 364 fully extended opposite to closing position, and the double acting spool valve is moved opposite to closing. This concept resembles our U.S. Pat. No. 4,351,490 issued Sep. 28, 1982; However, that design proved to be too limber, and its open design subjected it to being jammed by rocks filling its spaces and labor and lost time to clear jamming, and slide pads were not very satisfactory; our new concept incorporates an arcuated inner wall extending from base plate 352 to cover 381; said wall is only open to accommodate the size and travel of pawl 370; an outer wall is flat and tangent to inner wall but has openings to access for assembling and servicing the members that activate the adjusting mechanism; said walls are spaced apart by end members 353, 354, 355, 357, and 382; member 357 is configured to cope with substantial thrust and pulling forces; spaced apart triangular plates 358 are welded to 357 and are drilled to accept pin 359; plates 358 straddle the “eye” plate of cylinder 360; a hole in member 351 aligns to said holes in 358; pin 359 extends from outside of sideplate 351 to through the inner plate 358, and said pin is retained in place by an arm and cap screw not shown but is similar to 368; section 383 is cut out of said wall and then is attached to cover 381; this enables it to assist the partial closure of 350 but allows assembly of ram 364 and pawl to rest on rollers 365, best shown on page 22 FIG. 45; to assemble rollers axle 387 is slid into the horizontal holes of blocks 367 and through the lowest roller 365; all rollers are identical; vertical axle 386 is entered into 367, and its stepped end is locked against turning by the end of 387; a notch in axle 387 accepts the step of a second 386 axle; both 386 axles pass through rollers before entering the lower blocks 367; when axle 385 is inserted and arm 368 is secured by cap screw 392 all axles are locked in place and cannot turn within blocks 367. There are a set of identical roller assemblies near the end walls 353 and 382. Ram 364 has a bracket 363 welded to it at a specific location; the ram of unit 360 is pinned to said bracket by a second pin 359; ram 364 is tilted to the same angle as the thread angle, but the pawl 370 is angled relative to said ram to make it 90° to the lugs 244; this enables grippers 373 and 374 bear against lugs 244 without any vertical rubbing nor wear. Oil lines 376 and 377 when pressurized activate member 375 to open or close pawl 370; lines 361 and 362 when pressurized activate member 360 to push or pull ram 364; P.O. (pilot operated) check valves lock cylinder rams at whatever position each may be. Cover 381 has closures 383 and 390 attached to it to inhibit entry of contaminates; extended covers 380 cover ram 364 the full extent of said rams travel.

### BRIEF DESCRIPTION OF THE DRAWINGS

Having introduced the purpose of this application, we now list the numbers that we have assigned to its parts. We refer to drawing pages 1 through 22 and FIGS. 1 through 49. The purpose each part serves will be explained later.

Page 1 FIG. 1 is a perspective view of our fully assembled rock crusher; 1-MF is the main frame; 1-BA is the bowl assembly; 326 is an adjusting unit; 341 is a gas charge accumulator; 281 are hook-like members; 275 are hydraulic cylinder assemblies; 294 are anchor plates; 293 are manifold tubes; 290 are manifold to cylinder tubes; 298 are thrust absorbing members; 24 is a lube oil drain; 224 are anti-rotation stop blocks; 222 are depending arm anti-rotation stops; 220 is a bowl nut; 243 is an adjustment ring.

Page 2 FIG. 2 shows a perspective view of the main frame with hydraulic cylinders 275 and hook-like members 281 tilted outward; 276 are connecting links; 1-BF is a base flange, and 1-W is a cylindrical wall of the main frame 1-MF; 218 is a V-ring; 119 is a wear mantle; 342 are lifting brackets.

Page 3 FIG. 3 is a vertical section view through the crusher; 331 is a spacer brace and a wear protector; 263 is a wear liner; 333 is a large socket head cap screw; other numbers are detailed in subsequent FIGs; plus other numbered features that cannot be shown in this view.

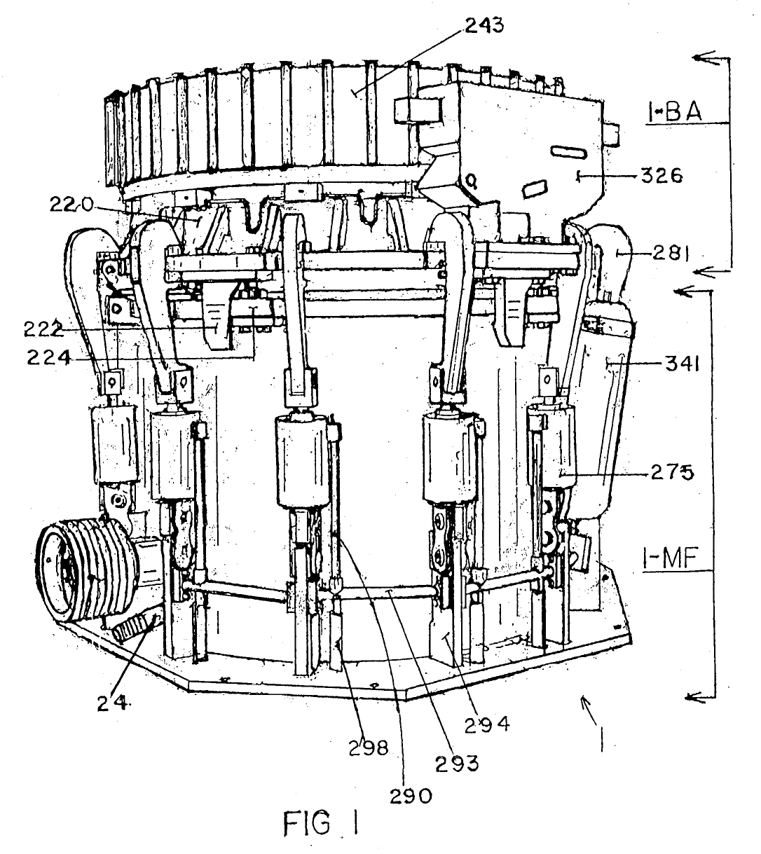

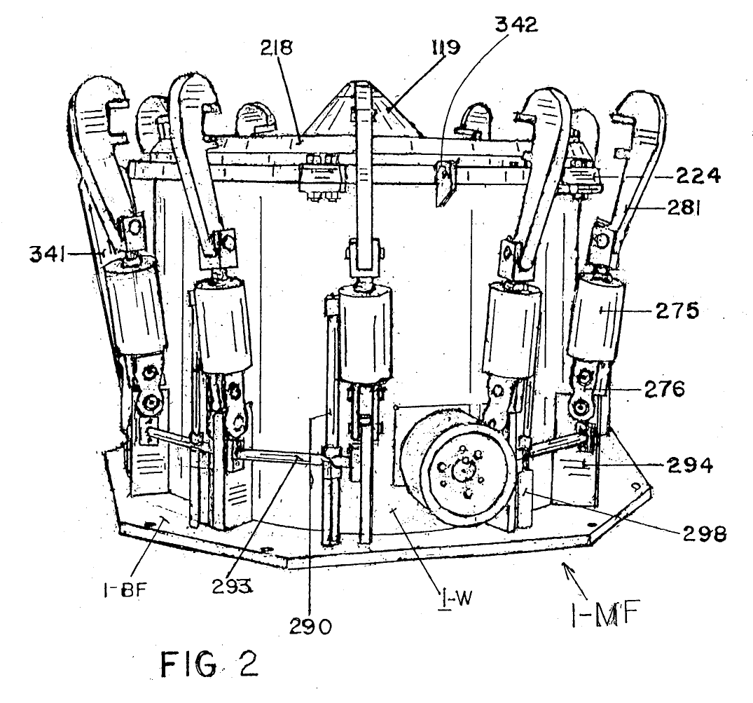

Page 4 FIG. 4 is a plan view of the lower half of the main frame; 1-BF is the bottom flange of said main frame; 2 are beams; 3 are end plates welded to beams; 4 is a bearing housing support with precision bore 22 and drain port 24 integral; 5 are support plates for 4; 7 is a bearing housing support; 23 is a precision bore in 7; 6 are arcuated walls; 9 are upright members; 10 is a circular plate member; 12 is a centering pin in 10; 12-H is a centering hole in beams 2; 11 are lube oil conducting members; 8 are attachment shelves; 20 are cover plates; FIG. 5 is a vertical sectioned view through B-B′ FIG. 4; 35 are oil drain ports in beams.

Page 5 FIG. 6 is a vertical sectioned view taken through C-C′ of member 10 FIG. 7 showing centering pin 12, 17 are lube oil holes, 19 are threaded holes, 18 are drain holes, 13 is an oil deflector ring, 28 is a precision recess, 29 is seal groove, 32 is a seal ring shoulder. FIG. 7 is a plan view of member 10: 21 is a precision bore, 30 is a gear inspection hole, 142 is a lube hole 14 is an oil trap; 33 and 34 are larger oil holes than 17, 25 and 26 are heating/cooling fluid holes, 27 is an annular oil drain; FIG. 8 is a detail view through E-E′: 16 are recesses for elastomer seals at the top ends of all oil and heating/coolant holes shown in FIG. 7. FIG. 9 is a detailed view of 13 and 27 taken through F-F′ FIG. 7; FIG. 10 is a detailed view taken through D-D′ of FIG. 7 showing deflector 14 and nozzle 15.

Page 6 FIG. 11 is a plan view of the top of member 38 a fixed spindle; 40 is a bolting flange with counterbored holes 41; 42 are flutes (grooves) with tapered edges; 44 are three evenly spaced smooth bored holes; 45 are evenly spaced threaded holes; 47 is opening for a gear; 46 are multiple threaded holes in a recessed face; 43 is a conical surface; FIG. 12 is a vertical view of 38; D is a large diameter of taper 43 and D′ is its small diameter; 48 is a cylindrical extension of D′ diameter; 49 are hydrostatic lubrication grooves; 39; are annular grooved lube oil distributors. FIG. 13 is a detail of grooves 39 and 55 oil lines; FIG. 14 details transfer nipples 50 with one of two elastomer seal rings 51 in place.

Page 7 FIG. 15 is a plan view of the bottom face of spindle 38; 41 are multiple bolt holes; 52 are multiple lube oil holes; 55 are oil holes; 53 is a fluid inlet; 54 is a fluid outlet; FIG. 16 is a vertical sectioned view of spindle 38 taken through gear opening 47; 61 is a cast hollow chamber; 62 is an overflow exit tube; 57 is a fluid tight tubular chamber; 56 is a precision bored recess; 58 is a solid disk; 59 is an elastomer seal ring in 58; 60 is a retaining ring; FIG. 17 is an enlarged view of annular grooves 39 Page 8 FIG. 18 is a vertical view of 65 a conical eccentric member; 66 are flutes with tapered edges; 68 are oil holes with tapered threads at outer ends; 70 is a keyway; 2X is the diameter between A-1 and A-2 arcs, FIG. 19. FIG. 19 is a plan view; 67 are slots open at the large end of the taper of 65; A-1 is an arc of less than 180°; A-2 is a smaller arc than A-1; X are radii between said arcs and of shorter radius than said arcs. FIG. 20 is an enlarged view of 68; FIG. 21 is an enlarged view of nozzles 69.

Page 9 FIG. 22 is a vertical sectioned view through the plane of the eccentric 65; 64 is a cylindrical extension concentric to centerline 102; 63 is a cylindrical extension concentric to centerline 101; 72 is an annular groove; 72-H are oil vent holes; 69 are nozzles; 74 is a centering bore; 101 is the centerline of inner cone 73; 102 is centerline of outer cone of 65; angle α is established by 101 and 102; FIG. 23 is a plan view of the bottom; 70 are one or more keyway slots; 71 are multiple threaded holes on radius R-5.

Page 10, r. FIG. 24 is a plan view of the eccentric drive plate 150; E is the eccentric offset and the center of radial line R-1; radii R-2, R-3, and R-4 are centered on the machine's center line 101; E/2 is the center of R-5 bolt circle; 192 are cap screw holes on said bolt circle; 70 are keyways; 18 are multiple lube oil drains; 155 are up standing bars; 399 are counterweight clamps; 104 are threaded holes; FIG. 25 is a vertical partially sectioned view showing eccentric 65 with drive keys 77, an internal tooth gear 130 bolted to 150, 155s embedded in 150 and retained by cap screws, and a section of a labyrinth seal ring 36. 80 are dust seal retaining bosses.

Page 11 FIG. 26 is a plan view of a section of cone head 75; FIG. 27 is a vertical view of the exterior cone-head 75; 76 is a conical area raised above the conical surface of 75; 80 is a dust seal retaining boss; 119 is a sectioned view of a mantle (wear liner); FIG. 28 is a plan view of the lower surfaces of 75; 78 are multiple struts; 79 are cavities; 83 is a flat surface; 85 is a conical surface; 86 are precision spaced holes; 87 is a precision bore.

Page 12 FIG. 29 is a vertical section view of cone head 75; 100 is the apex of center lines 101 and 102; 103 is the amplitude of gyration; 81 is a converging conical bearing surface; 82 is a cylindrical bearing surface; 89 is gyrating clearance; 83 is a precision recess with threaded holes 84 in its face; 92 is a conical surface; 88 is a smooth precision cylindrical bore; 85 is a conical surface; 86 are precision spaced blind holes; 90 is an annular seal ring groove; 91 is an extended cylindrical section.

Page 13 FIG. 30 is enlarged vertical section view of an assembled cone head; 93 is a piston; 94 is a cylindrical extension threaded into 93; 95 is an elastomer seal ring; 96 is an elastomer seal ring; 97 are pins; 105 is a copper ring; 120 is backing material; 98 is a conical washer-spacer; 99 is a cap screw with a double conical head; 122 is a protection wear cap retained by cap screw 333 see FIG. 3; 334 is a set screw and nut; 110 is the body of a valve; 118 is an oil hole; 121 is an oil pump extension; 106 is a spherical thrust bearing member; 107 are cap screws; 108 is a universal joint; 109 is half of a jaw clutch with a conical extension; 103 is the amplitude of gyration. FIG. 31 is an enlarge sectional view of 110; 111 is a ball; 112 is a spring; 113 is a headless screw with a hex hole through it; 114 is a ball; 115 is a vent; 116 is a cap screw; 117 is an oil gun fitting.

Page 14 FIG. 32 is a vertical section view through the drive train gearing; 124 is a bearing housing extension of shaft enclosure 156; 125 is an input shaft journaled in bearings 131; 134 is a bearing adjustment mechanism; 138 is a sealing member; 139 is a wear sleeve; 329 is a closure cover; 136 are shims at two places; 137 is a seal ring; 145 is a dike; 126 is a spiral bevel pinion gear; 127 is a mating spiral bevel gear (both too difficult to draw the teeth); 128 is a vertical gear shaft; 129 is a spur gear; 130 is an internal tooth gear; 192 are gear and eccentric retaining cap screws; 133 is a roller bearing; 140 is a spacer; 141 is a spacer oil slinger;132 is a ball bearing; 134 is a retaining nut and locking washer; 135 is a bearing housing; 143 is a bearing retainer plate; 142 is an oil passage way; 24 are oil drains to a reservoir not shown; 36 are dust seals; 37 is a seal ring spacer; 151 are counterweights; 153 are spaces between counterweights; 154 are spacers; 152 are fine tuning balancing weights.

Page 15 FIG. 33 is a vertical section view of thrust bearing member 160 mounted on spindle 38; 161 is a bearing quality metal bonded to 160; 163 are adjustment shims; 162 are retaining cap screws; 164 are arcuated closed end galleries machined into 161; 165 are jacking screws; 50 are lube oil transfer nipples; 174 is the female half of jaw clutch 109; 158 is a tubular motor mount; 159 are cap screws; 167 is a hydraulic motor; 168 is a valving member; 379 are cap screws; 170 is a universal joint; 171 is a male spline shaft; 172 is a female spline; 173 is a coil spring; 191 is a port opening in 158; 190 is a vent opening in 158; 166 is a pressure relief vent in 160. FIG. 34 is a cut away view of 168; 180 is a valve seat; 181 is a ball; 179 are bolt holes; 182 is stop pin; 183 is a closure of a machining access; 184 is an oil passage way; 185 is a hole; 186 is a ball; 187 is a coil spring; 188 is a pressure adjusting screw; 189 is a two way oil flow passage; 194 is an optional venting port.

Page 16 FIG. 35 is a plan view of our hydrostatic lubrication system and heating/cooling fluid connections; 200 and 201 are flow dividers; 203 is a flow proportionator; 195, 196, and 197 are connectors to hydraulic hoses from a pump source; 198 are T fittings; 199 are lube oil tubes from 198 to flow dividers; 204 and 205 are multiple lube oil tubes to members 11; 210 are distribution tubes to specific connections; 207 and 206 are larger tubes with different flow volumes; 208 and 209 are heating/cooling fluid connectors; 292, 293, and 295 are detailed on page 19 FIG. 42.

Page 17 FIG. 36 is a vertical section view of the top frame assembly 1-BA; 220 is a bowl nut; 240 is a bowl; 221 are platform extensions of 220; 218 is an annular V-ring pressed into the main frame 1-MF; 219 is one of several grease fittings; 222 is a depending arm; 223 is a platform welded to main frame; 224 is a stop block; 225 is a drain hole; 263 is a wear liner; 120 is backing; 246 are cavities between struts 245; 260 are cover plates welded over said cavities; 241 is modified thread form; 242 and 243 form an adjustment ring; 244 are equally spaced lugs welded to 243; 235 is a locking nut; 234 are thrust rods; 232 are pistons; 230 are cylinders; 231 are cylinder retaining cap screws; 233 are hydraulic lines joining cylinders 230; 245 are gussets forming openings 264; 268 is a depending band joined to 235; 247 are elastomer dust and moisture seals; 248 is a hopper for 250; 265 is a bowl wear liner; FIG. 37 is an enlarge section of female thread 226; 227 is a small annular groove cut in the thrust flank of 226; 228 are multiple lubrication holes into 227 and having threads for fittings. FIG. 38 is an enlarged plan view taken through G-G′; 250 is a slidable wedge; 253 is a thrust absorbing member; 251 is a cover washer; 254 is a bolt; 255 is a nut; 256 is a washer; 252 is a clamping cap screw; 259 is an elongated slot; 257 is a vertical slot in 250; 258 are guides; 266 is a wedging ramp with a conical radius; 261 is a 360° dike.

Page 18 FIG. 39 is an enlarged vertical view of part of the top frame 1-BA; 235 a locking nut; 268 is a metal band; 236 is an elastomer seal; 230 is a partially sectioned hydraulic cylinder; 231 are cap screws; 232 are pistons; 245 are gussets; 233 are connecting tubes or hoses; 269 is an expansion/contraction configuration for tubes; 270 is a hydraulic hose from a power source. FIG. 40 is an enlarged plan and vertical section view of multiple cylinders 230; 237 is an elastomer seal; 271 is an oil passage through 230 with a side hole into each cylinder chamber.

Page 19 FIG. 41 is a tangential vertical view of one assembly of our relief system; 294 are anchor members; 246 is a hole for oil passage; 299 is a valve; 295 are header plates; 299 is a valve; 276 are links; 277 are pins; 278 are retaining rings; θ is a limiting angle; 279 are air filters; 275 is a sectioned view of a cylinder assembly; D is cylinder diameter; S is ram diameter; 280 are clevises; β is a limiting angle; 281 are hook like members; 282 are concave discs; 283 are convex pads having positioning stems; 284 are precision holes; 285 are spherical headed shoulder pins; 286 are threaded blocks with headless screws; R is a long radius centered at lowest 277 pin ; r is a shorter radius centered at clevis pin. FIG. 42 is a radial view of FIG. 41; 287 is a lubrication fitting; 293 is a tube manifold with slip connector 292 joined to it; 275 is a partially sectioned view of a whole cylinder; 297 are saddle blocks; 298 shows the top end of a thrust transfer member; 296 is a threaded hole into one 294; 289 is a 90 deg. attachment to 275; 290 is a connecting tube of d diameter; 300 is an air bleed valve; 301 is a spacing pad.

Page 20 FIG. 43 is a sectioned view of a relief cylinder; 306 is a partially sectioned piston; 313 is a back-up ring; 314 is an elastomer seal; 315 is a non metallic band; 316 is a pipe plug; 307 is a piston rod of S diameter; D is cylinder diameter; D′ is a diameter larger than D; 318 is a travel space; 317 are elastomer seals; 323 is a taper in 292 and 289; L is the distance from the center line of 275 to the center line of 290; N is an offset; 303 is a taper; 324 is an eye plate welded to 275; FIG. 44: 305 is a threaded cylinder head; 322 is a seal ring groove 308 is an elastomer seal; 310 is a bushing; 309 is a retaining ring; 311 is an elastomer seal; 312 is a rod wiper; 320 are wrenching flats; 321 is a taper thread; 319 are recesses for pin wrench.

Page 21 FIG. 45 is a tangental vertical partially sectioned view through our power adjustment system 326 and part of top frame 1-BA. 222 is a depending arm; 223 is a fixed platform; 224 is a reversible stop block; 352 is a base plate; 353 are spacing end plates; 354 is a spacer plate with hydraulic couplings through it; 355 is a spacer plate with slot 356 through it; 357 is an angle iron spacer and thrust absorbing member; 358 are gussets welded to 357; 382 is a spacer end plate. 350 is an arcuated inner wall; 351 is a flat outer wall; 360 is a push/ pull hydraulic ram; 359 are coupling pins; 361, 362, 376, and 377 are hydraulic hoses; 364 is a sliding bar; 363 is a bracket welded to 364; 365 are guide rollers; 385 are key axles; 368 are axle locking arms; 383 is a section cut out of wall 350. FIG. 46 is a plan view of FIG. 45; 242 and 244 are a section of the adjustment ring 243; 370 is a bi-directional pawl; 371 is its pivot axle; 372 is an axle locking arm; 373 and 374 are extended grippers; 375 is push/pull hydraulic ram; and attached to cover 381; 380 are cover guards over 364;

Page 22 FIG. 47 is an inside vertical section view of one of the roller assemblies of 326; 367 are axle supports; 385 and 387 are horizontal axles and 386 are vertical axles; 389 are threaded holes; cap screw 392 locks arm 368. FIG. 48 is a plan view of FIG. 47; end spacer plate 382 is cut out for bar 364 at both ends; plates 390 FIG. 47 fill openings above 382. FIG. 49 is an end view of 326 adjusting assembly; 390s are attached to cover 381; 391 are clamps to hold 380.

18 is for all drains not otherwise numbered and is used in several different FIGS.

### DETAILED DESCRIPTION OF DESIGN OF PREFERRED EMBODIMENTS

Page 1, FIG. 1 shows a perspective view of a fully assembled rock crusher that is the subject of our invention. The numbered parts are shown in detail on pages 3 through 22 and FIGS. 3 through 49 of the drawings. In FIG. 1: 341 is one of two gas-pressurized accumulators; a second accumulator, out of view, works in parallel with 341 to provide ample capacity for their duty which is to minimize pressure increase caused by rapid inflow of oil compressing the gas confined within an elastomer bag inside the steel chambers of the accumulators; this construction is a spring with an extremely low spring rate as compared to coiled steel springs, and coil springs have a very limited travel before their coils contact together. However, a cylinder-piston design can be of any useful travel if the accumulators are of adequate capacity. Both accumulators are connected to manifold tubes 293; vertical tubes 290 conduct pressurized oil from 293 to the tops of the hydraulic cylinders 275; this makes the cylinders of the pull design. Hook shaped members 281 are connected to hydraulic cylinders 275. Columns 298 transfer the thrust of 290s into the main frame 1-MF, because 290s have slip connections at each of their ends and therefore act like pistons. The object of this new concept is to provide extremely rapid and easy removal of the bowl assembly 1-BA from the main frame; two workers can release the accumulator pressure and tilt the swing hooks and cylinders clear of the flange of 1-BA and attach lifting cables and a crane with an operator can have the bowl assembly sitting on the ground within twenty minutes; other designs common in cone crushers require several man hours to remove large nuts and nut locking devises plus careful guidance by several men when lifting their bowl assembly over many large threaded rods and repeating such care at reassembly. For example: our new unique system enables two men plus a crane operator to remove the bowl assembly from the main frame, remove worn mantle and bowl liner, replace with new, pour backing epoxy, and fully reassemble within three hours in the more popular mid size crushers; no other cone crusher can closely match this. When down time is factored in of such costly operations as rock plants are, the cost savings of our design are enormous! 24 is a lube oil drain to a reservoir not shown; 224 is one of several stop blocks that resist the torque of depending arms 222. In cone type crushers there is a main frame, and resting upon it is a removable bowl assembly that is designed to lift when uncrushable objects enter the crushing chamber; also there is a tendency for the bowl to “float” slightly during very severe crushing; these actions causes the bowl assembly to try to creep relative to the main frame; this can not be permitted, hence the anti-rotation stops; usually there is wear between anti-rotation stops with all makes of cone crushers, with our design 224 is reversible and 222 can be removed, repaired with weld metal, and reattached; this can also be done with 224. Pressures in GAS over OIL design are adjusted to resist lifting of the bowl assembly when crushing rock but to allow lift by uncrushable objects; Louis Johnson, co-inventor of this application, is the original inventor of combining accumulators with hydraulics for rock crusher protection systems; see Johnson U.S. Pat. No. 3,118,623 and U.S. Pat. No. 4,192,472. 1-BA is a bowl assembly that contains a rotatable member to which is attached 243 adjustment ring; 326 is one of two opposed power adjusters that rotate 243, when activated the crusher product is sized as desired.

Page 2 FIG. 2 shows the main frame with bowl assembly removed; hooks 281 and cylinders 275 are tilted outward to their stop positions thereby providing ample clearances for lifting the entire bowl assembly; 218 is a hard steel V-ring pressed into the top of the main frame, and upon which bowl nut 220 seats, FIG. 1; 119 is a wear mantle seated on a cone-head and retained by a combined hydraulic piston and cap screw unit; 342 is one of three lifting brackets; 276 are links that connect 275 to 294 and allow limited tilting of 275.

Page 3 FIG. 3 is vertical section view taken through the gear train; it shows how most of the parts fit together; the numerous numbers are required to point out all the new concepts of our invention as well as those parts that are not new art but essential to assist in understanding our machine, 331 braces the wall 1-W to maintain the exact spacing between 1-W and plate 4 and to prevent any erosion of bearing housing 156 by falling rock; 263 is a sectioned wear liner that protects wall 1-W from rock erosion and is held by bolts for easy replacement; 333 is a large socket head cap screw that holds wear cap 122 which protects 99 a conical headed cap screw; FIG. 30 page 13 details said concepts. Other numbers are detailed in the following pages.

Page 4 FIG. 4 is a plan view of lower section of the main frame; 2 are full depth crossbeams spanning across the inside diameter of 1-W less the thickness of endplates number 3 the outer faces of which are machined to the same radius as 1-W's inside diameter; beams 2 are configured to have near uniform strength across their lengths; one beam is full length with two half length beams minus thickness of first beam forming the other beam; all said beams are prep machined including drains 35 before being fully welded together to form a 90° X frame; the central top faces of said beams are machined flat and square to the vertical centerline of said main frame; members 8 each are blind threaded to receive cap screws and are then positioned and welded to each side of beams 2 in all four quadrants; arcuated members 6 are premachined prior to being positioned at the same radius through three quadrants; the bottom faces of 8 and 6 are on the same plane; members 4 and two 5s form a support for a bevel gear housing. All members forming said quadrants are fully welded before the upper faces of members 4, 5, and 6 are face machined simultaneously with beams 2 with all in the same plane; the radius of members 3 are machined concentric to the frame's axis and to the same radius as the inside diameter of wall 1-W, and lower ends are machined 90° to centerline and to an exact distance below the top faces of beams 2; cover plates 20 are attached to 8 and 6 with gaskets between by cap screws at final assembly of a complete machine. Member 10 is fully machined before welding; pin 12 is inserted at its center before it engages hole 12-H which centers 10 on beams 2; bore 21 in member 10, page 5 FIG. 7; 10 is positioned precisely with a gage over bore 23 in plate 7; 10 is welded to 2s at specified places and fully welded to 4, 5, and 6; welding is accessible through the openings that will be closed by covers 20; this procedure forms four oil tight chambers and adds strength and stiffness to beams 2 and saves time and costs of vertically machining the two bores later and premachines parts that are inaccessible after assembly. After this procedure is complete, the assembly is positioned on base flange 1-BF and secured with welds; cylinderical wall, 1-W, is a rolled steel plate without its ends joined; it is wrapped around said assembly with one end centered on one end plate 3; 1-W is forced to match a circular score line etched into 1-BF when it was premachined and is tack welded as necessary when being positioned through 360°; its joining gap is then welded about the height of member 3. A top flange 1-TF, FIG. 3, is machined to an inside diameter equal to the outside diameter of members 3 plus two wall thickness of 1-W, and the outside diameter is oversized, and one side is faced with a small chamfer at its inside diameter, and 1-W has a small hand ground chamfer at its outer top edge to facilitate said flange to being forced over said wall to an exact distance above 1-BF; both are skip welded as 1-W is forced against 1-TF free of any gaps; anchor plates 294, FIGS. 3 and 41 page 19, are positioned and partially welded. The whole assembly is now ready for complete welding; after which the top inside diameter of 1-W and top face of l-TF and its O.D. are machined to specific dimensions. Any top face warpage to 10 by welding is corrected by machining at this time. Upright members 9 are supports for shield 336 FIG. 3. FIG. 5 is a vertical sectioned taken through B-B′; it shows the full depth of beams 2, the frontal position of members 4 and 5 with precision bore 22 that supports a pinion shaft housing 156, oil drains 24 and 35, and the position of member 7 that serves both as a cover and support for a bearing housing, bearing, a vertical shaft with a bevel gear attached, and the separating forces of the bevel gear. Arrows show where member 10 will be placed. A cutaway in the 2^{nd} quadrant shows the end of a member 11 within a member 6 and oil holes drilled through 11.

Page 5 FIG. 6 is a vertical sectioned view of member 10 taken through C-C′ FIG. 7. 10 is a steel plate of substantial thickness to cope with severe stresses and to provide adequate depth for recess 28 and threaded holes 19 and for the width of a roller bearing in bore 21; 32 is an annular positive angled shoulder over which is shrunk fit a seal ring spacer. FIG. 7 is a plan view that details member 10's construction before welding to beams 2 and arcuated members 6. The top face of member 10 is recessed at 28 to exact inner and outer diameters to match a press fit to member 38, FIG. 12 page 6, a spindle; the walls of 28 absorb huge shearing stresses; multiple holes 19 are precision drilled and threaded for large cap screws to pull said spindle tightly against the bottom face of recess 28; bore 21 is precision bored an exact distance from center for accurate gear meshing; a roller bearing seats in this bore; holes 17 with recesses 16 FIG. 8 are precisely positioned as are holes, 33, 34, 25, and 26 to match holes in said spindle; 30 is a gear inspection hole; FIG. 9 is an enlarged section of groove 27, an annular recess to divert oil to drains 18, and a boss for positioning member 13; multiple drain holes 18 are positioned to avoid being obstructed by beams 2; hole 12-H is drilled on center to accurately position member 10; boss 32 is machined to hold a seal spacer; the bottom surface of member 10 is faced, and holes 17, 25, 26, 33, 34, and for nozzle 15 are threaded; hole 142 is drilled after the base frame is virtually completed. FIG. 9 details 13 a lube oil deflecter to channel oil to drains 18. NOTE number 18 is used at several places and FIGs to represent oil drains. FIG. 10 details 14 an oil trap to force lube oil into nozzle 15 that ejects lube oil just ahead of the meshing of gears 126 and 127.

Page 6 FIGS. 11 &12 shows a spindle 38 that is force fit into recess 28 in member 10 by multiple cap screws. This construction accommodates both shearing and tipping forces that are huge in cone crushers, and because it is secured by cap screws and extracted by jack screws, this spindle is easy to service or be replaced by a new one even as the main frame remains in its working position. Other makes of cone crushers that use an embedded post shaft design have extreme difficulties to extract its shaft because of the very tight shrink or press fits extending through the full depth of their center member as such designs require, and such machines must be removed and be hauled to a repair shop if their post shaft must be replaced, all of which is very costly and time consuming. Except for the crusher design of this patent application all other cone type crushers whether post shafted or open for an eccentric mechanism have massive deep and wide annular center sections cast integral with radial arms and are recessed to accommodate a large bevel gear; these crushers must be built as such to resist deflecting cycling forces which cannot be totally contained; such construction adds substantially to the weight and costs of those machines. Such stresses and deflections do not transfer into our bearing design. FIG. 12 shows the conical construction, 43, of our new concept design that has a cross-sectioned area at D dimension and a smaller cross-sectioned area at D′; subtracting area at D′ from area at D gives an area equal to an area in a plane of the same outside and inside diameters. We use this as a thrust bearing area. A cylindrical extension 48 of D′ diameter stabilizes an eccentric member, 65 FIG. 18 page 8, when the hydrostatic oil film between the conical surfaces is too thick. The area difference of D minus D′ is substantial enough to provide an adequate hydrostatic thrust bearing when lube oil under pressure is injected into flutes 42 and between bearing surfaces; the conical shape is large enough to eliminate diametral clamping by thermal shrinkage of metals of different coefficients of expansion, a severe problem with straight shafted crushers that use bronze bushings, because such bushings are heated by friction and try to expand against a much stronger steel or iron housing which is cooler and has a lower coefficient of expansion by a factor of about 60%; the results are the bushings are compressed, and when the crushers are shut down and bushings cool, they shrink to a smaller diameter and would clamp and seize to shafts they work against; the only way such crushers can cope with this phenomenon is to have excessive bearing clearances larger than the amount of shrinkage, but this in turn greatly reduces radial bearing area caused by diverging arcs and also causes inaccurate meshing of bevel gear drives, because the larger gear orbits true center by whatever the extra clearance may be which causes reverse end loading of the gear teeth during every 180° s of rotation. Also constant shrinking and expanding between operating and shut down of the machine causes myriads of tiny cracks in the bushings that resemble a dried mud flat; the oil film is disrupted adversely affecting lubrication. Our one piece design sans bushings permits a nearly uniform oil film thickness through 360° because any differences of expansion between dissimilar metals is accommodated by the eccentric member lowering on the tapers if it expands, and if it shrinks, it climbs relative to the spindle on which it runs; while the eccentric loading may force a slight difference in oil film thickness to absolute true running, it is of no consequences, because our eccentric gear's teeth are parallel to its axis, vertical movements and meshing clearances accommodate any slight changes in depth of meshing. With its hydrostatic lubrication our bearing finds its bearing clearances in proportion to the imposed loads; injected oil is at a volume and pressures that prevents metal to metal contact; the results are running accuracies comparable to roller bearings, with very low friction and wear and not subject to cracking as with bushings nor fatigue spalling as are roller bearings. Original and maintenance costs are substantially less with our design. However, our hydrostatic bearings were not without fault; when operating unloaded, a surplus of oil and varying viscosities caused too thick an oil film which created instability to the eccentric and cone head; after extensive testing we corrected the problem by adding the short cylinderical sections, 48 FIG. 12, at the top portion of the spindle to stabilizes the eccentric and cone head 75 FIG. 3 and FIG. 27 page 11. FIG. 11 is a plan view of the top of said spindle; 40 is a bolting flange; 41 are multiple countersunk holes for large socket head cap screws; 43 is a conical super accurate smooth surface its full length; 39 are two annular grooves that deliver lube oil to holes rotating with an eccentric member 65; said grooves are detailed in FIG. 13 with oil holes 55; tubes 50 with seals 51 transfer hydrostatic lube oil across a shimming space 163 between said spindle and a thrust bearing body, 160 FIG. 33 Page 15; 49 are spaced apart annular grooves around extension 48 to supply hydrostatic lubrication between the bearing surface of 48 and eccentric member 65; 44 are three equally spaced smooth wall holes for tubes 50; 45 are threaded holes for retaining said thrust bearing; 46 are multiple threaded holes for retaining a tubular chamber 158 FIG. 33; 47 is a chamber enclosing a spur gear. Surfaces 43 and 48 are machined to near zero tolerances and extremely smooth finishes; the fluting 42 in the spindle is evenly spaced above and below the annular galleries 39. Oil volume is proportional between to the areas of the two zones, but is equalized to each flute by flow dividers; lube oil is supplied at whatever pressures and volume required; the varying loads of crushing vary the operating clearances, and the escape rate of oil at the ends of each bearing is similar to a variable valve, but at some point of clearance the escape rate reaches a limit that prevents further restrictions of closure because the pump pressures are always greater than crushing pressures, and volume is virtually constant. Our research has not revealed that a unidirectional conical hydrostatic bearing capable of coping with simultaneous radial and thrust loading has ever been used before in any kind of a machine. A thrust bearing positioned on top of said spindle is held in place by a slight press fit in bore 56 FIG. 16 page 7, and by cap screws threaded into holes 45; FIG. 14 details tubes 50 sealed by O-rings 51 that transfer lube oil across the space between the spindle and thrust bearing providing hydrostatic lubrication from gun drilled holes from the base of 38 to holes 44 which transfer oil to tubes 50.

Page 7 FIG. 16 shows a vertically sectioned view of said spindle an alloyed steel casting capable of being cryogenically hardened after machining; 61 is an as cast hollow chamber with an inlet 53 designed to swirl incoming fluid, and an overflow outlet 62 designed to flow a heating/coolant fluid through said chamber thereby heating or cooling the actuating members of the machine as local weather temperatures and operating temperatures may require, and to help keep lube oil at an optimum viscosity range; heating or cooling from the inside out is more efficient, safer and simpler than flame heating the outside of the gyrating assembly as is done when other cone crushers are shut down between shifts in very cold weather, and heating or cooling lube oil is done within an exterior tank. Said fluid flows through a heating unit or through a fan cooled radiator, or in extremely hot climates a chiller maybe needed before said fluid enters cavity 61; 52 are gun drilled holes to conduct lube oil to each designated flute 42 and to thrust bearing 160 some of which is shared with grooves 49; 56 is a precision bored recess for a tight fit with thrust bearing body 160; 57 is a fluid tight tubular member to enclose a hydraulic motor 167 page 15 FIG. 33; 58 is a solid disc cover with a sealing ring 59 and is retained in place by ring 60 that engages a groove; an option is to weld 58 fluid tight; its purpose is to prevent heating/cooling fluid from mixing with lube oil; oil lines and heating/cooling lines from members 11 connect to designated connections in member 10; holes 17 align to holes 52, and hole 33 aligns to hole 55 and hole 34 aligns to other hole 55; holes 52 and 55 carry lube oil; holes 53 and 54 carry a water antifreeze mix; all said holes are sealed with elastomer seals in recesses 16. Holes 52 deliver lube oil in equal volume to designated flutes in said spindle 38 to lift and lubricate eccentric 65 and to the thrust bearing less what goes to grooves 49; oil holes 55 FIG. 17 deliver lube oil to annular grooves 39 that continually supply lube oil to holes 68 through eccentric member 65 as it rotates around the spindle, page 8 FIGS. 18 and 20, to lubricate the conical bearing surface 81 of cone head 75 and matching surface of eccentric 65. Hole 53 delivers and swirls heating/ coolant fluid to chamber 61 within said spindle, and tube 62 withdraws it near the top of said chamber; this insures a full chamber of agitated fluid.

Page 8 FIG. 18 show a vertical exterior view of the eccentric member 65 which is a non-ferrous bearing quality casting; the taper of outer conical surface FIG. 18 is an exact match to the taper 81 of cone head member 75 page 12 FIG. 29; 64 is a cylinderical extension having two spaced apart bearing arcs, A-1 and A-2 and in between arcs of X radius. Because it is not possible to use flow dividers to control oil flow to the outer bearing surface, we use exchangeable nozzles 69 FIGS. 19 & 20 and detailed in FIG. 21 to vary the hole sizes to force the oil volume as best served, the eccentric offset through 180°; said nozzles, usually pipe plugs drilled through, have tapered threads and are positioned at the exit of each hole 68 whose inner ends center on grooves 39; holes feeding lower flutes 66 rotate around the lower groove 39; upper flutes receive oil from the top groove 39; lube oil that ejects out of the top of the spindle and out of the thrust bearing 160 works again as it passes between the bearing surface of eccentric 65 and 81 of member 75; open ended valleys 67 drain lube oil to prevent pressure build-up in the space above the eccentric, because hydrostatic bearings must discharge lube oil into low or zero pressure conditions to perform as intended. The eccentric does not contain bushings; it is a one piece member and has four bearing surfaces, two conical and two cylindrical; FIG. 19, a plan view, has an inside diameter, 63 FIG. 22 page 9, with just enough diametral clearances for oil film and thermal contraction to rotate freely around extension 48 of spindle 38; outer bearing diameters of extension 64 have arc A-1 of less than 180° and a spaced apart arc A-2 that have minimal operating clearance co-acting with bearing surface 82 in FIG. 29 page 12; said arcs are equally centered to the plane of the eccentric; radii X form large arcs between arcs A-1 and A-2 and have substantially shorter radii which form very large clearances that can absorb excessive thermal expansion should it occur by bulging radially enough to eliminate clamping against surface 82 FIG. 29 page 12; the eccentric metal is flexible enough to allow said bulging without excessive bearing pressures on arcs A-1 and A-2. The conical angles of FIG. 18, and cone head, FIG. 29 are held concentric to their centerlines as is a spherical thrust bearing 106 to said spindle FIG. 30 page 13 and 160 FIG. 33 page 15.

Page 9 FIG. 22 is a vertical section view 90° to the plane through the eccentric offset. 73 is the inner conical bearing surface that rotates about spindle member 38 concentric to centerline 101 as does cylinderical bore 63. 72 is a annular groove that accepts hydrostatic oil that escapes from the top of the taper 73 and funnels the oil outward through holes 72-H to prevent back pressure from the close fit of cylindrical bearing 63. Discharged oil exits just ahead of arcs A-1 and A-2 for additional lubrication. 102 is the centerline of the outer cone and bearing extension 64 and is canted by angle α which establishes the radius of gyration of cone-head 75. 66 is a profile view of a typical lubricating flute with a nozzle 69 in a hole 68 positioned to receive oil from the upper annular groove 39; the cutout section shows a 69 receiving oil from the lower 39. Keyways 70 and keys 77, page 10 FIGS. 24 and 25, transfer driving torque and accommodate thermal expansion and contraction without distorting eccentric member 65; cap screws holding 65 to an eccentric drive plate, 150 page 10 FIGS. 24 and 25, have sufficient clearances in holes 192 to accommodate differential thermal movements of said eccentric. 74 centers eccentric 65 on its drive plate 150. FIG. 23 is a bottom view showing the normal positions of keyways 70 and threaded holes on R-5 radius, also shown are holes 68 exiting the conical inner surface.

Page 10 FIG. 24 is a plan view of the eccentric drive plate 150; it is attached to said eccentric 65 by cap screws in holes 192 drilled on R-5 radius and is driven by keys 77 FIG. 25; radii R-2, R-3, and R-4 are centered on the main centerline of the machine; R-1 is a varying radius from centerline 102 that reaches its maximum at the largest conical diameter of eccentric member 65 and diminishes to zero at apex 100; 104 are threaded holes for attaching counterweights; FIG. 25 is vertical sectioned view of member 150 showing partial assembly with 130 an internal tooth gear that drives the eccentric member; it is attached to the underside of 150 by multiple cap screws and is shouldered to run concentric to main centerline 101; a section of 36 a labyrinth dust seal seated against shoulder 80 is shown; it is concentric to 101. 18 are oil drains that flow lube oil back to a reservoir. The combined weights of the cone head 75, mantle 119 FIG. 27 page 11, and part of the eccentric establish a center of gravity that when gyrating eccentrically creates centripetal forces that must be neutralized; this is done by counterweighting; the extended R-4 radius provides about half the required counterweight, and most of the extra weight required is provided by weights 151 FIG. 3 and fine tuned by weights 152 (see page 14 FIG. 32) that can be changed without removing the cone head. Pins 155 embedded in holes with clamping washers 399 plus long cap screws in threaded holes 72 hold all upper counterweights against centrifugal forces. The spinning counterweights generate considerable air turbulence within the open chamber below the cone head; circular shields, 336 page 3 FIG.3, supported on upright members 9 page 4 FIGS. 4 and 5, direct air flow upward and downward rather than radial; this reduces rock dust erosion of the counterweights and directs some air flow into cavities 79 of said cone head member thereby producing some cooling effect to it. 80 is a positive angled boss to retain seal 36 by shrink fit

Page 11 FIG. 26 is a segmented plan view of the top of the cone head; FIGS. 27 shows a vertical view of the exterior configuration of the cone head 75, this is the member that is gyrated by the eccentric and performs the crushing action; 119 is a wear mantle that is firmly clamped, detailed on page 13 FIG. 22, to said cone head and prevents wear on the cone head itself Depending on the abrasive characteristics of the rock being crushed, the wear life of 119 can be from a few days to years. Because of the extreme difficulty to machine the wear material, usually manganese steel, we choose to employ a fairly narrow machined surface 76 to support the mantle at its rim this leaves a space inward that is filled with a liquid epoxy backing, FIG. 22, that hardens in a short time; 80 is a boss for retaining a sealing ring; FIG. 28 is a plan view of the bottom; 78 are struts that transfer crushing forces into the conical wall of bearing surface 81, FIG. 29 page 12; 79 are spaces between said struts to reduce weight, costs, and make easier to counterbalance; 84 are threaded holes to retain a conical thrust bearing; 86 are two or more holes evenly spaced in conical surface 85, we prefer using three, that lock a piston from rotating; 87 is a precision bore that serves as a cylinder.

Page 12 FIG. 29 shows a vertical sectioned view of said cone head; 81 is an extremely accurate conical and smooth bearing surface that journals on the eccentric 65; 91 is an extension of the cone head that serves as an oil deflecter and a protection of surface 81; 82 is a smooth bore cylindrical bearing surface that co-acts with the eccentric's bearing surface 64 FIG. 22 to stabilize the conical hydrostatic bearing section below; 89 provides gyrating space around thrust bearing 160 FIG. 33 page 15; 83 is a precision recess to retain 106, FIG. 30 page 13, the convex half of thrust bearing 160; 92 is a short steep taper to assist the installation of a large elastomer seal ring; 88 is a smooth cylindrical bore in which a piston slides; 85 is a conical surface to match the top conical surface of a piston; 86 are clearance holes for pins 97 FIG. 30 page 13; 90 is a seal ring groove, and 87 is a smooth bore for a piston extension to slide.

Page 13 FIG. 30 details the assembly and functions of parts that retain said mantle 119 and comprise one of the most important elements of our invention and claims. Piston 93 combines a mild steel disk having a steep tapered female buttress thread into which a very high strength steel cylindrical member 94 is assembled with an anaerobic sealant and tightened to refusal; 94 has an internal thread that accepts the male thread of cap screw 99 with a free fit; the wall thickness of 94 provides more tensile strength than 99 in case a breakage should occur; 94 has a valve assembly 110 threaded into the recessed face of its threaded bore; a hole 118 is angle drilled from above the first thread of its taper into the hole containing 110. Seals 95 and 96 provide leak proof retention of high viscosity oil that is pumped into the space between said seals. When installing a new mantle it is lifted by a crane or other means and preferably using our safe lift device (U.S. Pat. No. 5,323,976) and placed over and centered on cone head 75; said lifting device is removed, and conical washer 98 is positioned; large cap screw 99 having a double conical head is threaded into 94 and hand tightened with a pin wrench to pull piston to face to face contact of its angled surface. FIG. 31 is an enlarge sectioned view of 110; an oil pump extension 121 engages fitting 117 through a threaded hole in 99; pumped oil flows past ball valve 111 and out hollow hex screw 113; cap screw 116 is slightly loose until all air is ejected, then it is tightened forcing ball valve 114 to be firmly seated; oil is then pumped into 117 until the piston is pulling between 200K and 800K lb.s depending on the size of the crusher; these forces are easily obtained with our new system but extremely difficult with sledging against a wrench to turn the screw or nut as in all other designs. Epoxy backing 120 is poured through holes cast near the top of the mantle During crushing the mantles on every kind of gyrating crushers tend expand due to pressures of crushing; this phenomenon causes the mantle to creep relative to its cone head in the direction the cone head gyrates; this results in the cap screw or nut, whichever is used, becoming so tight that it is impossible to unscrew; the hand of the threads are determined by the direction the cone-head gyrates at time of manufacture of the machine, so that it will continue to tighten, if the threads were the other hand the mantle would loosen which could have disastrous results, consequently a cutting torch is necessary to relieve the enormous pressure and friction; either a torch ring is used, or the washer is cut, which then another must be purchased, or the mantle is cut with an arc-air electrode because manganese steel cannot be cut with gas torches; these are time consuming and costly methods that have been and still are unavoidable until now. To prevent the piston from turning with its cap screw in our new concept we use pins 97 pressed into the piston and engaging clearance holes 86; when mantle changing time comes, wear cap 122 that has been held in place by a cap screw 333 is removed, and a small socket wrench on an extension handle opens screw 116; oil pressure is releaved through port 115; the cap screw 99 can be unscrewed with a hand wrench; the work is easy; the time is fast, and nothing has been destroyed. However, nothing mechanical is fool proof, and should the hydraulic oil escape from its containment the cap screw will draw the piston tightly against surface 85; in that event washer 98 can serve as a torch ring; copper washer 105 prevents a cutting torch flame from damaging the surface of the cone head, because copper can't be cut by a cutting torch. Nut 334 was left in place at time of assembly to enable our safe lifting device to be reattached and used to lift off the worn mantle; a setscrew that was threaded into said nut at the time of installing a new mantle to protect the nut from filling with epoxy and later by rock dust must be removed first. Other members of FIG. 30 are thrust bearing 106 having a case hardened and polished spherical surface on a radius centered at apex 100 and is retained in recess 83 by cap screws 107. A universal joint 108 in a recess is held by cap screws; 109 is one half of a jaw clutch fastened to said joint 108; its conical projection is to guide said clutch into its mating half which is a blind assembly in an inaccessible position; these are parts of a cone-head anti-spin device page 15 FIGS. 33 and 34.

Page 14 FIG. 32 shows vertical sectioned layout of our double reduction gear train; 125 is the powered input pinion shaft; it is journalled in tapered roller bearings 131 in tubular housing 156; 134 is mechanism to adjust said bearings to correct operating clearance; 138 is a sealing means against entry of contaminants and escape of lube oil; 139 is a replacible wear band to protect the shaft from a rubbing seal; 329 is a cover plate retaining said seal; 126 is a spiral bevel pinion gear keyed and shrunk fit to said shaft; 137 is elastomer seal ring to seal against oil loss; 142 is a passage way in combination with dike 145 to deliver lube oil to outer bearing 131; a small drain tube drains this oil to main oil drain 24; 136 are shims for adjusting pinion gear mesh with mating gear 127; 128 is a vertical shaft with spur gear 129 preferably made integral but could be a separate gear keyed and shrunk fitted to shaft l28; roller bearing 133, flinger 141, and spacer collar 140 position gear 127 to an exact position from gear 129 and ball bearing 132; by positioning bevel gear 127 above bevel pinion gear 126 the torque pressure on 127 and counter torque on spur gear 129 greatly reduces the loading on bearings 133 and 132; the radial loading on inner bearing 131 adjacent to gear 126 would be the same regardless of rotation direction; bearing 132 is capable of handling thrust loads in either direction as well as radial loads; it is retained in fixed position in housing 135 by retaining plate 143 and cap screws; lock washer and nut 134 hold 132 firmly against the shoulder of shaft 128; 136 are adjusting shims for gear 127 meshing with 126; both gears require meshing adjustability; this system insures obtaining and maintaining proper bevel gear meshing; spur gear 129 does not require meshing adjustment; gear 130 is attached to eccentric drive plate 150 which in turn is attached to eccentric 65 as previously shown in FIG. 25; when lube oil enters between said eccentric and spindle 38, the eccentric assembly lifts to a level that balances the oil escape rate to the weight of the assembly; oil viscosity is also a factor; when the pressures of crushing begin, the assembly is forced down to a thin oil film; total variations of vertical movement between running empty to maximum loading may reach two millimeters; straight tooth gears accommodate these variations; any radial runout is accomodated by extra depth cut into these gears. FIG. 32 also shows labyrinth seals 36, seal spacer 37, counterweights 151, air spaces 153 for rock dust to escape thereby minimizing dust from buildup on the inside surfaces of the weights, spacers 154, and fine tuning balancing weights 152. A very important advantage of this design is its elimination of the massive gear well of other cone crushers and permits the use of full depth crossbeams for greater strength with a substantial reduction in weight and costs, especially so because structural steel is about 30% the cost of cast steel and much less subject to flaws. 18 are oil drains; 35 are drain ports in beams 2.

Page 15 FIG. 33 is a vertical sectioned view of the thrust bearing 160 and cone head braking mechanism; 161 is a bearing quality over-lay of bronze welded to steel member 160; however, such over-lay could be other bearing quality metals e.g. Babbitt or hard plastics. 164 are radial lube oil grooves spaced apart by closed ends and are supplied with oil by tubes 50 with sealing rings which transfer hydrostatic lube oil across a shimming gap between spindle 38 and member 160; cap screws 162 pull member 160 into a tight fit in recess 56 and to hold same; jack screws 165 are used in adjusting shims 163 and to extract 160. The thrust bearing is positioned vertically to support the cone head a predetermined distance above the eccentric; this distance is the sum of the sines of the desired oil film thickness of the spindle angle and the outer angle of the eccentric. The lubrication of the cone head conical surface 81 is mostly hydrodynamic, but is assisted with some hydrostatic lift. When cone crushers are running idle (not crushing), the cone head will tend to spin with the eccentric because of frictional drag; this is undesirable; Louis Johnson, co-patentee of this application, invented the first head brake for cone crushers, U.S. Pat. No. 3,207,449, in which he used an over-running clutch, and which others have copied; the problem with such clutches is they cannot endure shock reversing impact nor torque loads above their capacity; when this happens they rupture or shearing devices are used to prevent rupture; such clutches are expensive to buy and more costly to replace. Our new concept uses a hydraulic motor 167 with a valving mechanism that permits free turning in one direction but resist turning in the opposite direction; an enlarged view of the valve FIG. 34 details its operation; when crushing the cone head turns slowly retrograde to the eccentric and must not be restrained. To allow turning freely oil is drawn in through valve seat 180 and around ball valve 181; a stop pin 182 limits the travel of 181; oil flows through passage way 184 and into the motor through port 185 and out the motor through port 189, but when bearing friction tends to turn the cone-head with the eccentric oil is then drawn in through port 189, and ball valve 181 closes; for oil to escape it must force ball valve 186 to open which compresses spring 187; bypassed oil can be vented through hole 194 or through hollow hex screw 188 which is drilled to exhaust oil; the screw adjusts the spring force to just enough resistance to override head drag, but not enough to permit harm to co-operative parts if somehow the cone head adheres to the eccentric; to machine passage way 184 it is necessary to have an opening which is closed later with weldment 183; cap screws 379 hold valve body 168 oil tight to motor's porting face. At assembly of cone head to the thrust bearing and eccentric which is a blind assembling procedure, jaw clutch cone 109 automatically finds alignment to female cone 174 and slides into it, but it is unlikely that the projecting lugs of 174 will find slots 193 in cone 109 initially in which case spring 173 yields and spline 172 slides on 171 as needed; after the cone head is fully in place, and the lube oil pump is started, the head is easily turned by hand in the drag direction, thereby finding alignment where spring 173 will push the jaw clutch to full engagement; the universal joints convert eccentric rotation to inline rotation; The motor is suspended by tubular member 158 which is torque restrained by cap screws 159; fluid tight enclosure 57 prevents intrusion of heating/cooling fluid; lube oil escaping inward from said thrust bearing 160 fills the enclosure 57 and motor mount 158 through port 191 to the level of port 166; any air in the enclosure vents out hole 190 and 166; any excessive pressure is relieved through hole 166 and valleys 67.

Page 16 FIG. 35 shows how the lube oil flows in our hydrostatic design; 200 is a flow divider that apportions oil equally to the flutes 42 in the lower zone of spindle 38; said oil flows out of 200 into tubes 204, into members 11 on each side of beam 2, and into three chambers formed by members 6, 10, and 20; members 11 are flat bars of steel of ample sizes to protect oil passage ways drilled through them from the ravages of falling rock; wear caps 335, FIG. 3, further protect members 11 and beams 2. Flow divider 201 equally apportions oil to the upper zone of said spindle and also to the thrust bearing 160 through lines 205; proportionator 203 ratios the oil to annular grooves 39 through lines 206, and 207; both lines deliver their oil to their pair of members 11; the lower groove gets the larger portion of oil from 203 because it supplies a larger bearing area; multiple lines within said chambers conduct their portions to specific connections in member 10; return oil drains through holes 18 in 10 into all four chambers, then through ports 35 in beams 2 and out exit port 24 to a tank not shown; lube oil drawn from said tank passes through filters and heat exchangers before reentering the machine; a three chambered pump supplies oil to connectors 195, 196, and 197. Heating/coolant fluid normally water and antifreeze mix enters through 208 and out 209 after circulating within chamber 61; said fluid also passes through heat exchangers as it circulates through the system. Numbers 292, 293, 295 are members of the safety relief system page 19.

Page 17 FIG. 36, A machine that crushes rock by compression has a stationary member and a moving member to form a squeezing force; in a cone crusher the stationary member is called a bowl which in this patent application is number 240; multiple gussets 245 brace the conical wall of 240; 246 are open spaces between said gussets. To protect the bowl from wear a bowl liner 265, a casting of wear resistant metal, is positioned in the bowl where it seats on conical surface 267; to retain it in place, we have designed a sliding wedging system using three or more wedges 250 evenly spaced circumferentially and to bear against an inverted conical flange machined at the top of said liner; FIG. 37 is a plan view through section G-G′ that details their construction: thrust bolts 254 are locked from turning by vertical slots 257 as thrust wedges 250 are forced inward as nuts 255 are turned; blocks 253 absorbs the thrust, and washers 256 protect 253 from wear of turning said nuts; cap screws 252 and cover plates 251 prevent wedges from tipping and are tightened after all wedges are tight; slots 259 provide travel of wedges relative to cap screws; rectangular plate washers 251 are constructed to always cover said slots to prevent debris from entering slots; 258 are guides to prevent skewing of wedges; 266 is a wedging ramp with a conical radius to match liner's. When changing liners the bowl assembly is removed from the base frame as previously explained; the hopper is unbolted and lifted out by a crane; nuts 255 are turned toward the bolt heads far enough for wedges 250 to clear the liner's flange at the same time cap screws 252 are slightly loosened; if necessary the wedges are tapped outward; the worn liner drops out, and the bowl assembly is lifted and placed over a new liner, and the liner is lifted into place, and all wedges are slid under the liner's flange; then each wedge is forced inward in a manner to center the liner and then tighten the wedges securely; cap screws 252 are tightened. A backing material 120 usually epoxy, but could be molten zinc, is poured in its liquid state but soon turns solid. Not shown are pouring spouts built in to save workmen from making them every time new liners are installed. This design eliminates the time and expense of caulking places where liquid backing could leak, a problem with most other cone crushers. Hopper 248 is replaced and the bowl assembly is ready to install in the main frame; a process that is just as quick and easy as it was to remove, about twenty minutes, as compared to several man hours with other cone crushers. The hopper keeps rock away from damaging wedging system members.

A crusher must have a means of adjusting for whatever size product maybe required and to compensate for wear of liners; Most gyrating cone crushers use a threaded means to achieve that; a problem with threads is potential galling between two similar metals especially so if adjusting while still crushing; to cope with this problem we provide a small groove on the loaded face of the female thread, 227 FIG. 38, in the bowl nut 220 and a means of injecting special greases either by hand pumps or automatic lubricators through multiple places 228; the start and end of said groove are blocked as well as intermittently between said 228s; this is to prevent grease from escaping endwise and to obtain some hydrostatic separation. A lock nut 235 is restrained from turning by means of three equally spaced pins, 330 FIG. 3, but can move vertical a short distance; after an adjustment is made, hydraulic fluid under pressure forces multiple pistons 232 against thrust rods 234 which causes said lock nut to lift bowl 240 and hold it firmly against thread flank 226; all cylinders are connected in series by tubes or hoses 233; said pressure is maintained between adjustments by a P.O. check valve at the control console not shown. An adjustment ring 243 is bolted to the top flange of bowl 220, and it has vertical lugs 244 evenly spaced around its perimeter to engage pawls of the adjusting system, page 21 FIGS. 45 and 46 detail the power adjusting system. V-ring 218 has a means of receiving injected grease 219 to minimize fretting between it and bowl nut 220. 263 is a replacible abrasion resistant liner bolted to the inside of wall 1-W to protect said wall from erosion of the crushed rock; it is made in sections to facilitate replacing. 245 are bracing gussets with openings 264; hydraulic hoses for the adjusting means can be passed through these openings for neater appearance. 222 and 224 are shown edge on. 262 is an elastomer dust excluder. Hole 225 drains any rain water that might leak into chambers 246.

Page 18 FIGS. 39 & 40 show in enlarged detail our bowl nut locking system; a gap between band 268 and a shoulder on the top flange of bowl nut 220 provides space for a dust excluder 236; multiple cylinders 230 are clamped to the underside of said flange by cap screws 231 that are sized to cope with whatever pressures are imposed on pistons 232; high pressure seals 237 retain pressurized oil, but if any leakage develops each cylinder is easily removed, seals replaced and re-attached; rectangular cylinder bodies are through drilled and threaded 271, to receive connector fittings, and all are connected in series by lines 233 either tubing or hoses; small holes from cylinder heads to holes 271 feed oil in or out of said cylinders; two hoses 270 approximately 180 deg. apart conduct hydraulic oil to and from all cylinders for balanced oil flow between a T connector and one hose to a control valve and a P.O. check valve in the control console.

Page 19 FIGS. 41 & 42 and page 20 FIGS. 43 &44 combine to show our new concept relief system; FIG. 41 is a tangental vertical view of one of several assemblies; 294 is an anchor plate welded to 1-W and 1-BF that resists the pulling force of cylinder, 275; FIG. 3 shows it and 298 in full. Links 276 and pins 277 couple said cylinder to 294; 278 are retaining rings to keep pins 277 in place; 280 is a clevis joining piston rod 307 to hook like member 281; 282 is a concave disk centered on the line of tension and lightly welded to 281 by welds 288; 282 centers on convex disk 283 that has either a projection or a recess and pin that centers it on holes 284 all equal-distant from the center-line of the bowl nut 220 and are usually equally spaced circumferentially; block 286 contains a headless screw and rests on an inward projection of 281 and is held in place by a small bolt; a spherical head shoulder pin 285 is secured in the lower end of hole 284; screws in 286 are adjusted to barely touch 285; this system prevents hooks 281 from disengaging pads 283 when the system is not pressurized. When the system is pressurized, entrained air is bled out by valve 300, then all cylinders pull 220 downward onto V-ring 218 with great force. During normal rock crushing tight contact is maintained between 220 and 218, but should a non crushable object enter the crushing chamber the forces generated will lift the bowl assembly and override the gas pressures in the accumulators as oil flows from the cylinders 275 through tubes 290 and 293 and into the accumulators; this compresses the gas (Nitrogen) somewhat, but because of the large size accumulators we use, pressure increases are not excessive. This system prevents disastrous damage to the crusher. Louis Johnson, a co-applicant to this patent application, was granted a U.S. Pat. No. 3,118,623 for a similar but less sophisticated system. As explained earlier our new system allows the assembly to tilt outward on radius R or just the hooks on radius r; to do this blocks 286 are removed; valve 299 is opened to relieve pressure and hydraulic hoses with quick couplings are uncoupled; either a lever is placed under the projections supporting 286 and 281s are pried off of pads 283, or a special tool using hole 302 is used; all this can take less than ten minutes for two men; three lifting cables are attached to brackets 342 and to a crane hook, and within ten more minutes the bowl assembly is resting on the ground on its downward extension arms 222. The benefits are extremely rapid and easy removal of the bowl assembly for changing wear liners or quick access to the interior of the gyrating mechanisms, and most important huge cost savings to its owner. FIG. 42 is a radial view; members 300, 289, 291, 290, and 292 are better shown in detail on page 20 FIGS. 43 &44. Manifold tubes 293 will turn within header plates 295 that contain sealing means on their inner faces and bores similar to 292 and 317; when 275 is tilted outward; tubes 290 slides within connectors 289 and 292 because 290 is centered on 293 which is a longer radius than radius R; this requires space 318 to allow sufficient slip distance; because 290 can slip, -it acts as a piston which tends to tip cylinder 275 opposite to 290 thereby putting side pressure on bushing 310 and bending forces on piston rod 307; to neutralize this force we use a formula that uses the area of D less the area of S divided into the area of d multiplied by L equals N where L is the centerline distance of 275 and 290, and then pads 301 are made twice N and are welded to one side of anchor plates; 297 is a saddle block that must be removed so 293 can be lowered far enough to extract 290 from its slip connectors; when in place it and column 298 support the thrust of 290. In FIG. 43 300 is an air bleed; 289 is fused to 275; 317 are high pressure elastomer seals; 323 is a small angle in 289 and 292 to accommodate both ends of 290 from binding in 289 and 292; 316 is a pipe plug to release air when inserting ram 307 into piston 306 when the threads are coated with an anaerobic locking fluid; 316 is then tightened; 313 is a plastic back-up ring; 314 is a high pressure elastomer seal; 315 is a nonmetallic wear band; 289 is a right angle connection fused to cylinder 275; 303 is a taper that in FIG. 44 a threaded cylinder head with seal ring 308 set in groove 322 seat against. High pressure seal 311 is installed; bushing 310 is inserted and retaining ring 309 is inserted; rod wiper 312 is inserted; the cylinder head assembly is slid onto ram 307; the piston and ram assembly is inserted into cylinder bore D; D′ allows seal to pass oil entry port without being damaged and also to facilitate unobstructed oil flow if pistons are ever pulled to touching the cylinder heads; cylinder head 305 is then screwed into 275 and tighten to refusal on taper 303; a pin wrench engages holes 319. 321 are taper threads to bind tightly with the tapered threads in clevis 280 which is next installed; the tops of links 276 are machined 90 deg. to center lines of pins 277 and stepped to clear welds this forces 275 to pivot at the lower pin hole of links 276; said links could be eliminated by having two members 324 spaced apart and welded to the cylinder head, but the link design gives more flexibility. Hook-like members 281 are pinned to clevis 280; a hole 302 is drilled in 281 on or near the center line of gravity of the assembly; this provides a simple means for lifting by mechanical means each assembly into working position, and the use of a tool to enable one person to swing the hooks outward and return to operating positions. Angles β and Θ are limiting tipping angles that stop 275 and 281 at positions that give ample clearance when removing and reassembling bowl nut 220

Page 21 FIGS. 45&46: 326 is one of two power adjusters set 180° apart for balanced torque that rotate member 243, an adjustment ring, to adjust the gap between bowl liner and mantle to obtain desired product sizes. 243 is bolted to bowl member 240 that when turned changes crusher setting. Our adjusting mechanisms work in parallel as follows: a control console, not shown, contains an electric motor driving a high pressure hydraulic pump powers all the adjustment cylinders and the hydraulic oil to the relief system; spool valves manually controlled or remotely controlled direct hydraulic oil in sequence. To close the setting the pawls 370 are swung open by cylinder units 375 and rams 364 are pulled to the left by cylinder units 360 to stopped positions; valves direct oil to 375 which pulls pawls 370 to swing inward gripping two opposed lugs 244 between grippers 373 and 374; lock nut 235 is depressurized, and ram units 360 push 364s thereby turning bowl 240 one chordal length between lugs; as 240 turns, pawls 370 are forced to move outward and inward slightly but enough to cause harmful pressures, this is alleviated by a small accumulator in series with 370s. At the end of the stroke of 360s the locknut is pressurized to hold the bowl to the new position; if desired to move more than one lug, the sequence is repeated as many times as necessary. To open the setting the sequence is same except the starting position has rams 364 fully extended opposite to closing position, and the double acting spool valve is moved opposite to closing and cylinders 360 pull. This concept resembles our U.S. Pat. No. 4,351,490 issued Sep. 12, 1982. However, that design proved to be too limber, and its open design subjected it to being jammed by rocks filling its spaces and cost labor and lost time to clear jamming, and slide pads that guided the equivalent to 364 were not very satisfactory. Our improved concept incorporates an arcuated inner wall extending from base plate 352 to cover 381; said wall is only open to accommodate the size and travel of pawl 370; an outer wall is flat and tangent to inner wall but has openings to access for assembling and servicing the members that activate the adjusting mechanism; said walls are spaced apart by end members 353, 354, 355, 357, and 382; member 357 is configured to cope with substantial thrust and pulling forces; spaced apart triangular plates 358 are welded to 357 and are drilled to accept one pin 359; plates 358 straddle the “eye” plate of cylinder 360; a hole in member 351 aligns to said holes in 358; pin 359 extends from outside of sideplate 351 to through the inner plate 358, and said pin is retained in place by an arm and cap screw not shown but is similar to 368; section 383 is cut out of said wall and then is attached to cover 381; this enables it to assist the partial closure of 350 but allows vertical assembly of ram 364 and pawl 370 to rest on rollers 365, best shown on page 22. Ram 364 has a bracket 363 welded to it at a specific location; the ram of unit 360 is pinned to said bracket by a second pin 399; ram 364 is tilted to the same angle as the thread angle, but the pawl 370 is angled relative to said ram to make it 90° to the lugs 244; this enables grippers 373 and 374 bear against lugs 244 without any vertical rubbing nor wear. Oil lines 376 and 377 when pressurized activate member 375 to open or close pawl 370; lines 361 and 362 when pressurized activate member 360 to push or pull ram 364; P.O. (pilot operated) check valves lock cylinder rams at whatever position each may be. Cover 381 has closures 383 and 390 attached to it to inhibit entry of contaminates; extended covers 380 cover ram 364 the full extent of said rams travel. Also shown are 222 and 224 that is bolted to platform 223 that is welded to I-TF; these are multiple anti-rotation stops that restrain bowl nut 220 from moving circumferentially. Another advantage of our depending arms design is a ready made means of supporting the bowl assembly at a convenient height when it is set on the ground or floor; other crusher designs do not have similar depending arms and therefore require wood blocking to elevate their bowl assemblies to convenient height to provide space to drop worn liners out of the bowl; their system is slow cumbersome, and unstable.

Page 22 FIG. 47s, 48, 49. FIG. 48 is a vertical partially sectioned view showing an assembly of rollers and axles; to assemble 387 is slid through first lower block 367 then through a roller 365 and into far block 367. All rollers 365 are identical. Vertical axles 386 are identical; first axle 386 passes through first upper 367, through a roller, and into a notch in 387; the second 386 repeats the first except it rests on the end of 387; lastly axle 385 is slid through fist top 367 through a top roller and into far upper 367; arm 368 and cap screw 392 lock it. This design prevents axles from turning in 367s and secures them in place. Threaded holes 389 in the top ends of 386 axles facilitate their extraction. In actual assembly ram 364 is placed before top axle and its roller are installed. FIG. 48 is a plan view showing all axle holes in all 367 blocks are in the same plane. FIG. 49 shows a typical end view of rams 364 extending through openings in members 353 and 382 and under slot closures 390 welded to cover 381.

It is understood that the form of our invention herein shown and described is to be taken as a preferred example of the same, and that various changes in the shape, size and arrangement of parts may be resorted to without departing from the spirit of our invention nor the scope of the subjoining claims.

Having thus described our invention, we claim:

1: In a crusher of the gyrating cone type a main frame formed by a circular wall of rolled steel plate having bottom and top flanges, and crossmembers forming a 90° shape; a base plate joined to said crossmembers and centered to the vertex of centerlines of said two crossmembers, three chambers under said base plate in three quadrants and welded securely and leak proof to the base plate and sides of said crossmembers; removable covers at the bottom of said chambers and oil passages through said crossmembers joining chambers for lubricant drainage. A chamber in the first quadrant formed to contain a vertical gear shaft with a bevel gear keyed and spaced on said shaft; the top end of said shaft having a spur gear either integral to shaft or keyed to said shaft; a roller bearing, an oil slinger, and a spacing collar between said spur gear and said bevel gear; said roller bearing is housed within said base plate member that is welded to said two crossbeams; the lower end of said shaft is journalled in an anti-friction bearing that can assume both radial loading and thrust loading in both directions; a means for adjusting the vertical position of said bevel gear. A bevel gear on a horizontal shaft meshes with said gear on said vertical shaft; said horizontal shaft is journalled on two spaced apart roller bearings; said bearings and shaft are positioned within a tubular housing that extends through the wall of said main frame and into said chamber in the first quadrant. An adjustment means to position said housing to obtain proper gear meshing; said housing is flanged for bolting to said main frame and is sealed against entry of contaminants; said horizontal shaft extends for attaching a power driving means. An exchangeable seating ring pressed into the top opening of said main frame. Spaced apart plates extending radially outside the main frame wall and welded to the top face of the bottom flange and as far vertically as the height of said plates. Said plates drilled to pass hydraulic fluid, drilled for retaining header plates for hydraulic tubes, and for anchoring the pulling of hydraulic forces.

2: As in claim 1, rectangular members drilled and threaded to conduct lubricants and to conduct heating or coolant fluid from the exterior of a main base wall to within specific chambers under said base plate of claim 1.

3: As in claim 2, lube oil lines from flow dividers to lube oil passage ways drilled through rectangular members; separate oil lines conduct controlled volume of lube oil from said rectangular members to individual connectors in base plate of claim 1.

4: As in claim 1, an annular base plate drilled for multiple lube oil holes spaced apart as designed; the bottom ends of said oil holes threaded to receive oil fitting connectors; the top ends of said oil holes recessed concentric to each of said oil holes to receive oil seals, two larger holes for entry and exit of a heating/cooling fluid machined similar to said lube oil holes; said base plate recessed to receive and hold an upright conical member against shearing forces, and holes aligned to oil holes in said conical member, and holes aligned to said heating/cooling fluid holes in said conical member, and threaded holes aligned to bolting holes drilled through a flange of said conical member.

5: In a crusher of the gyrating cone type an upright member having a conical bearing quality surface above a cylindrical section joined to a flanged section; said flanged section having multiple bolting holes and a flat bottom face; said upright member has a hollow interior and a pocket for a gear and means to prevent mixing of oil with a heating/cooling fluid.

6: As in claims 4 and 5, a conical upright member drilled to connect to multiple spaced apart grooves machined or cast into a conical zone beginning a designed distance from the large end of the taper to a designed distance short of an annular groove machined 90° to the axis of said member. An upper conical zone having multiple similar grooves beginning a designed distance from a second annular groove and terminating a designed distance short of the upper end said tapered upright member. Drilled oil holes from base surface of said conical member to crossholes from said grooves to intersect holes from base surface to cross-holes.

7: As in claims, 5, and 6, an upright conical member having a bearing quality cylindrical extension above said conical upper conical zone. Said extension having means of lubrication. One or more holes drilled from base of upright member to connect to cross-holes from root diameters of said two annular grooves.

8: As in claims 4, 5, and 6, an upright conical member having multiple oil holes positioned to supply oil pressured to supply hydrostatic lift and lubrication to lower and upper zones on the conical surfaces between said upright member, and an eccentric member journalled on said upright member. Said upright conical member having a conical taper angle larger than any conical angle that might permit radial clamping by shrinking of a member rotating on said conical member.

9: In a crusher of the gyrating cone type an upright conical member bolted to a base plate; oil ways drilled to supply oil to multiple vertical grooves on its exterior taper, and to two annular grooves between a lower zone and an upper zone and to a cylindrical extension. above said upper zone.

10: As in claim 9 an upright conical member drilled through to conduct oil to a thrust bearing bolted to top of said member. Tubular connectors with sealing rings close fit to matching holes in top of conical member and bottom of thrust bearing. Said connectors conduct oil across a space between conical member and thrust bearing.

11: In a crusher of the gyrating cone type an upright conical member attached to a base plate at its largest diameter; a thrust bearing attached with a forced fit to the top of said upright member and shimming means for vertical adjustment; cap screws retaining said thrust bearing and passing through said shims to prevent said shims from moving; said shims insertable and removable with thrust bearing in place. A jacking means to provide clearance between the top of said conical member and thrust bearing's seating face to provide space for inserting and removing shims and for extracting said thrust bearing.

12: In a crusher of the gyrating cone type an upright conical member having a lower flange drilled for insertion of multiple closely space socket head cap screws, interference fits at its outside diameter and its inside diameter with a supporting member machined to accept said conical member. Said support member drilled and threaded to receive said cap screws. Several threaded holes in said flange for jacking screws to extract said tapered member from its interference fit.

13: In a crusher of the gyrating cone type an upright conical member having an exterior taper of large enough angle to prevent radial clamping of another over laying member. A conical surface having a very smooth bearing quality finish, and upper and lower zones separated by one or more annular grooves; said zones each having several evenly spaced grooves each in approximately the same plane as the axis of the conical member, passageways from its base surface to join with intercepting passageways from said grooves, lubricant to flow from base to grooves all separate and individual. Within said conical member a hollow chamber for containing a cooling/heating fluid flowing in and out of said chamber. A concentric tubular member of a specific diameter extends downward into said chamber a designed distance, and an end cap welded liquid tight to said tubular member; the top end of said conical member machined to fit the outer diameter of said tubular member and welded liquid tight to said tubular member.

14: In a crusher of the cone type having an upright conical member, the top end having a machined inside diameter to accept the outside diameter of downward projecting cylindrical section of the body of a thrust bearing member with a slight interference fit, and threaded holes to receive cap screws; the top face of said conical member is 90° to the axis of said member through 360°; said thrust bearing member having said slight interference fit; its top face is drilled and countersunk to receive cap screws through the thrust bearing body and into said threaded holes in said conical member thereby holding said thrust bearing firmly. Said thrust bearing having threaded holes for extracting screws.

15: As in claim 14, an upright conical member having its top face machined to have threaded holes and between said holes smooth bored holes to receive tubular connectors to transfer pressurized lubricant between said conical member and a thrust bearing member, and said tubular connectors having sealing means to prevent the escape of lubricant.

16: In a crusher of the gyrating cone type a lower part of a thrust bearing having an attachment to an upright conical member for support; a steel body configured to said upright conical member an opposed face having a concave spherical surface the radius of which is centered at the vertex of the axis of said upright conical member and the axis of an eccentric member; said radius of a length somewhat longer than the finished surface of said thrust bearing. An overlay of bronze or other bearing quality material deposited on said steel concave and of a sufficient thickness to be machined and to retain an adequate wear life and to have a finished spherical surface having the correct radius and said thrust bearing having an opening through its axial center of a designed diameter.

17: In a crusher of gyrating cone type an upstanding conical member concentric to the centerline of a main frame and firmly attached to a base plate centered on crossbeams of said main frame. A rotatable member having the same inside taper as said upright conical member and the same large end diameter or slightly less diameter for wear compensation, and a cylindrical extension above the small end of said inside taper having its inside diameter concentric to said upstanding conical member, and between said inside taper and said conical extension an annular groove with drain holes through the wall of said extension. Said rotatable member has an outer conical taper that is larger in included angle than its interior taper; the centerline of the outer angle is offset and canted to the mainframe axis but intersects said mainframe axis at a designed distance above said rotatable member thereby establishing a vertex. A cylindrical extension above the small end of outer cone has arcs of varying degrees and radii with each centered on the outer angle. The offset creates a varying amplitude of gyration that is proportional to its distance from said vertex as said rotatable member is gyrated.

18: As in claim 17, a rotatable eccentric member having an inside conical bore open at both ends, an outside conical surface with its conical vertex above the vertex of said inside conical bore, vertices on the same centerline but forming an angle between their centerlines, holes joining the two conical surfaces, the inner ends of said holes aligned to annular grooves in an upright conical member, the outer ends of said holes entering grooves cut in outer conical surface, and nozzles threaded into said outer ends, and one or more grooves open at both ends to relieve hydraulic pressures in a chamber above said eccentric member.

19: As in claim 17, a rotatable one piece eccentric member without bushings normally composed of cast bronze but could be of other suitable material e.g. aluminum. The bottom face of said eccentric member is drilled and threaded for cap screws and keywayed for drive keys for attaching to a driving member. Said eccentric member having a conical bore and a larger conical outer surface.

20: In a crusher of the gyrating cone type a rotating member of designed thickness having one outer radius through 180° or less, tangential extending sides, a longer outer radius from one tangential side to the other tangential side. A bored hole is concentric to said two outer radii and to an upright conical member and has a larger bore than the diameter of the lower cylindrical section of a nonrotating upright conical member that it surrounds. The lower face of said rotating member operates 90° to its axis of rotation. A portion of its upper face is recessed parallel to its lower face and is attached and keyed to an eccentric member as in claim 17; an outer recessed portion is canted 90° to the centerline of an eccentric member having a conical surface of bearing quality which has an axis angular to the axis of rotation. Said canted surface is machined to retain a sealing ring and an annular recess for operating clearance of a gyrating eccentrically canted member and for draining lubricating oil and holes for draining said oil. The remaining top surface of said rotating member is parallel to the lower face.

21: As in claim 20, a rotating member attached to an eccentric member and having an extended diameter and thickness to serve as a counterbalance and support and attachment for additional counterweight plates as maybe required and embedded upright pins and cap screws to hold said additional counterweights against centrifugal forces and spaces between counterweight plates to allow fine dust to be ejected and to minimize dust buildup on the inside radii of said counterweights and spacing washers surrounding said upright pins and cap screws.

22: As in claim 21, a rotating member having means to attach fine tuning counterweights to the underside of said member and to do so without being hindered by any other members of the machine.

23: A rotatable member having an outer radius of 180° or less and two tangential edges terminating at a longer outer radius and a portion of the top face canted to the bottom face and includes holes and keys to hold and drive an eccentric member rotatably. Said longer radius extension is parallel to said bottom face and has a midpoint 180° to an eccentric offset. Said extension acts as a partial counterweight and a platform with means for attaching more counterweights to balance gyrating forces. The underside of said rotatable member is formed to receive and retain an internal tooth gear and a sealing ring. The portion of canted and offset top face is also machined to receive a sealing ring. Drain holes are drilled to convey lubricant through said rotatable member.

24: In a crusher of the gyrating cone type a segmented shielding means supported on cross beam means to surround and protect a rotating member or members from impacting material after said material has exited the crushing chamber. Said segmented shielding means may be installed or removed without obstruction by other members.

25: In a crusher of the gyrating cone type a gyrating member having a converging conical internal bearing surface for radial loading, a cylindrical internal surface above the conical surface, Said cylindrical surface terminating at designed length with a short taper to a larger cylindrical surface of a designed length that terminates against a flat surface. A cylindrical recess smaller in diameter than the cylinderical diameter that is between the first and second conical surfaces, a flat surface at the termination of said cylindrical recess, and said flat surface having threaded holes to receive fasteners; at the inside diameter of said flat surface is a short conical taper to a smaller cylindrical smooth surface extending axially a designed distance and terminating at a conical surface that contains holes parallel to the axis of said gyrating member; last said conical surface terminates at a smaller cylindrical bore that extends through the top of said member. In this bore is machined an annular groove of designed dimensions to retain an elastomer sealing ring. At the top exit is a flat surface. At the periphery of said flat surface is the top of a frustrum of a conical surface that diverges outward at a large included angle to a diameter terminating at an annular flat surface; a second conical surface extends from said flat surface to the largest diameter of said gyrating member at which a cylindrical section extends downward a designed distance terminating at a flat surface; at the inner diameter of said flat surface are alternating but evenly spaced struts and hollows joining the wall of the larger outer conical section to a smaller conical wall formed between said smaller wall and said bearing conical section; a diverging conical section extends outward to a narrow cylinderical diameter; a sealing ring retaining means is machined at said cylindrical diameter; a flat surface extends inward some distance to a second cylindrical surface that terminates a designed distance below said converging conical internal bearing surface.

26: As in claim 25, a gyrating conical member having a replacible wear member over-laying and matching the contour of said gyrating member on its outer conical seating area; inward conical surfaces are spaced for backing material; said wear member has a concentric conical recess to the axis of said gyrating member and of designed diameter; a conical spacer seats in said recess; a large cap screw with a double conical head seats into said spacer, and its threaded portion engages female threads in an extended cylindrical member; said cylinderical member is taper threaded into a piston member having a conical upper surface that has two or more close fitting pins projecting vertically from said conical surface and parallel to the axis of said gyrating member; said pins engage clearance holes in said gyrating member; a sealing means between piston diameter and a matching cylindrical bore in said gyrating member; a sealing means between said extended cylindrical member and smallest bore in said gyrating member; a valving mechanism in the bottom face of the threaded bore of said extended cylinderical member; a hole from the top tapered thread to valve hole in said cylindrical member; a means for injecting hydraulic fluid into and through said valving mechanism and into a cavity formed between said two sealing means; a threaded hole in said double conical head cap screw; a means to release said hydraulic fluid; a protecting wear cap retained over said cap screw. The wearing face of said replacible wear member may be of any desired contour.

27: In a crusher of the gyrating cone type a metal disk flat on the one side, the opposed side having a spherical shape with a radius equal to the distance of said spherical side to the vertex of two converging axis; said disk is centered in a matching recess of the member of claim 25 and is retained by cap screws; said disk having a center recess to contain a universal joint; one part of said joint is attached to the bottom face of said recess by cap screws, and its other part having one half of a jaw clutch attached to it; said jaw clutch having means to align for blind assembling with its mating half; said mating half is attached to one half of a slip spline; the other half of said slip spline is joined to one half of a second universal joint; a coil spring surrounds the assembly of joined splines and is partially compressed at assembly; a retaining means prevents the spring from disengaging said splines. Said spherical surface case harden and super finished

28: As in claim 27,a hydraulic motor is suspended by a flanged tubular member within a liquid tight chamber; said tubular member has an outward flange at its top end that is retained in place by cap screws within a recessed conical member as in claim 14; its bottom end is flanged inward and bored to match the boss of said hydraulic motor and is drilled and threaded for attaching said motor by cap screws and locking nuts. A universal joint as in claim 27 is coupled to said hydraulic motor.

29: As in claims 27 and 28, a pair of universal joints with a jaw clutch and a coil spring between, the upper universal joint coupled to an eccentric gyrating member, and the lower universal joint coupled to a hydraulic motor on centerline of a main frame to convert eccentric orbiting torque to concentric torque. A means to align and couple both halves of said jaw clutch for inaccessible blind assembling.

30: As in claims 27 and 28, a hydraulic motor coupled through a drive assembly of universal joints and a jaw clutch to restrain a gyrating member from turning with an eccentric driving mechanism when running freely, but does not resist retrograde rotation of said gyrating member when crushing rock or other crushable material.

31: As in claim 31 a hydraulic motor restrained against rotation in one direction but is not restrained in the opposite rotation by a valving mechanism having an intake valve that opens to allow oil to pass freely through the motor and out a discharge port without restrictions; however, when attempts to turn in the opposite rotation are imposed on the motor the intake valve closes, and oil is forced against a spring loaded valve that has an adjustment for varying resistance to said force; it is desirable to adjust spring force to hold against normal frictional torque but to open if torque from harmful causes occur.

32: As in claim 29, an assembly of universal joints, an automatic coupling of male and female halves of a jaw clutch, a splined slip connecting member, a coil spring urging splines apart, a means to prevent splines from separating, and all enclosed in a chamber that prevents the mixing of lubricant with heating/cooling fluids.

33: In a crusher of the gyrating cone type a safety relief system having accumulators connected in parallel to manifolds consisting of tubular members free to turn within header plates containing sealing means, and sealing means between said header plates and anchor plates as in claim 1, vertical tubular members from slip connectors joined 90° to said manifolds to 90° slip connectors fused to cylinder walls; said slip connectors have a close fit to tubular members at their entry but having diverging internal conical shapes starting at sealing means of said slip connectors, thrust supporting means for manifolds directly under slip connectors; cylinder members connected to anchor means by link and pin means; rods joined to piston means within cylinders extend through cylinder header means and have taper threaded means to couple tightly with clevises; hook like members pinned to devises and overlap a flange on a bowl nut means; self aligning disk means located between hook like members and said flange; lower halves of self aligning means are of nonferrous metal of convex form on one side and flat on the other side and are held in position by an integral extensions into holes in said flange or recessed to receive pin alignment; upper halves of self aligning means have concave shapes matching said lower halves and are grooved on top faces to width of hook like members to insure exact centering alignment of said hook like members prior to welding. A greasing means in upper halves.

35: As in claim 33, a safety relief system for cone type crushers having one option for tilting cylinders and attached hook like links as one, and an option of tilting hook like links only where cylinders an manifolds are not made to tilt.

36: In a crusher of the gyrating cone type a shaftless gyrating member having an axis eccentric angled to a main axis; a convex half of a hydrostatic thrust bearing centered to the eccentric axis and having an axial positioned recess and a universal joint attached within said recess; said universal joint having one half of a jaw clutch coupled to said joint, said clutch having a male conical extension to enable blind coupling with the other half of said jaw clutch which has a female conical shape to guide a male conical extension to couple jaws of said clutch; a concave half of a hydrostatic thrust bearing is centered on the main axis and mounted on top of an upright conical member that is bolted to a base member; said concave thrust bearing has a center opening large enough to accommodate a gyrating universal joint and jaw clutch; said clutch has a splined drive shaft to a second universal joint coupled to the shaft extension of a hydraulic motor. A coil spring to force both halves of jaw clutch to firmly couple; means to prevent said splines from uncoupling. The body of said motor is attached to a depending tubular member having a top flange bolted to a conical taper upright member. Said motor and attached tubular member is suspended within a larger tubular member built into said conical upright member. The body of said motor is restrained from rotating in either direction. A valving body that permits motor shaft to turn freely in one direction but retards in the opposite direction by a one way check valve that allows fluid to enter but not to escape. Hydraulic fluid is free to pass through when the motor turns in one direction but is restrained in the opposite direction by a second valve that is spring loaded but will allow fluid to pass when pressure overrides spring pressure; a means of adjusting pressure resistance, and unrestricted entry of fluid to motor in either direction of rotation.

36: As in claim 35, a valving body having an intake valve that allows free intake of fluid and to pass said fluid through its body but closes if fluid reverses flow; reverse flow is permitted if excessive pressures occur to override a spring loaded adjustable check valve. Said valve body configured to be attached to a hydraulic motor that is confined within a close fitting tubular housing.

37: As in claim 35, a hydraulic motor suspended within a tubular member configured to prevent mixing of lube oil and a heating/cooling fluid, suspending member vented to allow enclosing member to fill with lubricant and a vent in the enclosed chamber to relieve hydraulic pressures.

38: In a crusher of the gyrating cone type, a means of adjusting the space between the fixed wear member and the gyrating wear member to control product sizes and to separate a rotatable member from a fixed member, said means to be a fixed member having a female thread and a rotatable member having a male thread, said threads to be angled on their loaded faces at larger angle than the bisecting angle of the crushing chamber to avoid outward radial sliding; the female thread to have a greasing groove its full length with both ends blocked and blocked intermittently; lubrication holes from said groove between each blockage to the exterior of said fixed member; manual or automatic means of injecting grease into said holes.

39: As in claim 38, a means to clamp a rotatable member from turning within a fixed member while the machine is crushing; said clamping means to be a ring like member having at least one full internal thread and a means to restrain it from rotating, said clamping means to be forced vertically by hydraulic means, said hydraulic means to be multiple rectangular members bolted to the underside of a top flange of said fixed member, said rectangular members bored for short stroke pistons and connected in series by hydraulic lines and to a pressure source at one or more spaced places; centered over each piston is a vertical hole through said flange with a push rod reaching from a fully relaxed piston to flush with the top of said flange, and with all moving parts totally enclosed to prevent entry of moisture, dust, or other contaminants.

40: As claim 38, a means to power rotate a rotatable member; said means having an enclosing housing having an arcuated inner wall centered off the main axis of a bowl nut; an outer wall tangent to said arcuated inner wall and spaced outward by members at ends of said walls; said inner wall and lowest end spacers welded to a base plate that is drilled for bolting attachment; within said enclosed housing is a slidable member that extends through openings in uppermost end spacing members, roller assemblies near each opening, a push-pull hydraulic means pin connected to said slidable member and to a spacing member, said slidable member angled to same as thread angle; a swing pawl journalled to the inside face of said sliding member and having vertical bars at end of pawl and parallel to said axis; said bars spaced to straddle multiple evenly spaced vertical lug bars on a rotatable member; said pawls are actuated by hydraulic means; an opening in said arcuated wall to allow said pawl to swing through and travel within said opening the length of travel of said sliding member; said sliding member extends beyond said enclosure at each end of its length of travel covers to protect said extensions. A cover member encloses the top of said housing.

41: As in claim 38, two hydraulic powered members bolted to platforms integral to a fixed threaded member and spaced 180° apart for balanced tangential forces; said powered members having pawls that grip lug bars integral to a rotatable member for either push or pull directions; said rotatable member is attached to second rotatable member that is threaded into said fixed threaded member; said pawls are powered to engage and disengage gripping said lug bars; means to accommodate hydraulic oil captured between the pawls hydraulic cylinders and a control valve as pawls are forced radially throughout their arc of travel. Said powered members enclose their working members.

42: In a crusher of the cone type a rotatable bowl member having an internal conical chamber designed to receive and retain replacible wear liners; both bowl and liners have matching conical seating contact at the outer diameters of said liners; both bowl and liners have converging conical spaced apart surfaces that terminate at designed diameters; said liners have a near cylinderical vertical extensions terminating at a diverging conical flange of a designed cylinderical diameter of designed thickness; said seating contacts are machined surfaces as are diverging conical flanges, cylinderical diameters and top surfaces of said bowl liners; said bowl has an inside diameter slightly larger than said cylinderical diameters of bowl liners to enable bowl liners to pass their conical flanges through bowl's inside diameter. Slidable members having wedging ramps to match liners' conical flange and having elongated bolting slots and having outer ends with vertical extensions with slots to lock bolt heads from turning and bolts with nuts and washers bearing against fixed thrust members; washer plates covering said elongated slots and cap screws through said washers and slidable members; guides at each side of slidable wedges prevent skewing of said wedges.

43: In a gyrating crusher of the cone type an assembly of parts and members all interdependent to make a functionally operating machine: a main frame having a circular wall and having top and bottom flanges with 90° cross beams contoured for approximately uniform strength across their lengths and with end capping plates to distribute weld concentration where joining to said circular wall; one of said beams full length other beam in two sections abutting first beam and fully welded to same and said beams full depth at their mid section; a circular member is centered on said beams and welded to same; said circular member of ample thickness to support all gyrating members and non gyrating companion members and having an annular oil drain recess with multiple drain holes; multiple oil passages and two heating/cooling fluid passages drilled through said circular member; three arcuated walls welded to said beams and said circular member form chambers in three quadrants and in one separate quadrant a gear chamber; openings in said beams and within said chambers for oil drains; means to conduct lube oil and heating/coolant fluid from outer wall to within chambers formed by said arcuated walls; formed hydraulic lines from conducting means to specific connecting means in said circular support member and formed means to conduct and return heating/coolant fluid without mixing with lube oil and cover plates to close said chambers; a conical spindle secured in a tight recess in said support member by cap screws; said spindle having multiple passage ways for lube oil to specific outlets and with sealing means between said conical spindle member and said support member; said conical spindle having a hollow internal chamber with a low entry port with swirling means for circulating heating/coolant fluid and a high exit tube to insure a full chamber; a sealing means for said chamber and a sealing means between said spindle member and said support member. Flow dividers and tubing members to distribute incoming lube oil to specific connectors in conducting members from outside of said frame wall to inside of said chambers; connections for hoses to connecting members for circulating heating/coolant fluid. A horizontal input shaft journalled in roller bearings within a tubular housing having sealing means, and said shaft having a spiral bevel gear at its inner end driving mating spiral bevel gear of larger size driving its vertical shaft also journalled in anti-friction bearings and having a spur gear at the top end of said vertical shaft; a means for adjusting the proper meshing of said bevel gears; said spur gear meshes with an internal tooth gear attached to a rotatable member which is attached to a conical eccentric member which rotates on said conical spindle; sealing means between said rotatable member and said support member. Upon said spindle is attached a spherical thrust bearing vertically adjustable and having sealed tubular connectors to transfer lube oil between said spindle and said thrust bearing; hydrostatic means to lubricate said conical eccentric member and said thrust bearing. Oil holes from the inside conical bore of said eccentric member aligned to annular grooves in said spindle conduct lube oil into grooves machined into the outer conical surface of said eccentric member; said holes having varying sizes of nozzles to meter hydrostatic oil flow to a gyrating conical member. Resting upon said thrust bearing and journalled on said conical eccentric member is said gyrating conical member having a replacible wearing member retained on said gyrating member by hydraulic and threaded means; said gyrating conical member is restrained from turning in one direction but is free to turn in the opposite direction; hydraulic motor, valving means, universal joints with slip shaft and a jaw clutch are restraining means; sealing means between said gyrating conical member and said rotatable member. Said main frame has a V-ring inserted into its top flange and upon said V-ring rests a flanged member having an internal thread that has a groove in its loaded face; said groove is blocked at both ends and has intermittent blocking between said end blocking; between said intermittent blocking are lubrication means into said groove. At the bottom flange of said main frame multiple spaced apart anchor members are attached; all but two of said anchor members are ported for fluid passage; bolt holes above and below said ports; header means each side of said anchor means; said header means bored and sealed to align to headers on adjacent anchor members and sealed between header means and anchor members; hydraulic tubular manifolds extend from within header to within the next header except at power input sector and having one or more slip connectors, with sealing means, 90° to said manifolds; said manifolds turnable within said headers; said anchor members drilled and pinned and linked to hydraulic cylinder means; vertical tubular members joins said manifolds to said cylinder means; a rod means projecting from within said cylinder means is threaded into a clevis means; an extended hook like means is pinned to said clevis means and projects inward over said flange of said threaded member and is seated on said V-ring member with self aligning means between said flange and said hook like means; accumulator means connected in series with said manifold means and said accumulators are gas pressurized to a specified pressure range; hydraulic fluid is pumped into said manifolds, cylinders and accumulators to a specified volume and pressure; said cylinder means and said hook like means can be tilted outward after hydraulic fluid is drained to a reservoir; gas pressure in accumulators is retained. Said threaded flanged member contains a rotatable threaded member that is free to be turned by powered means when unlocked; a locking means has one or more threads above said flanged threaded member and is prevented from turning but can be moved vertically by multiple hydraulic rams bolted to under face of the top flange of said flanged member; means thereby locking and unlocking said rotatable member. Said rotatable member contains a replacible wearing member that is retained in said rotatable member by sliding wedges having slotted means for clamping by cap screws after being forced inward by thrusting means. Means to prevent circular movement of flanged threaded member relative to main frame member by downward projecting means attached to flanged member bearing against blocking means attached to top flange of said main frame.
